(19) United States
(12) Patent Application Publication
(10) Pub. No.: US 2016/0007024 A1
(43) Pub. Date: Jan. 7, 2016

(54) THERMAL AND POWER MANAGEMENT WITH VIDEO CODING

(71) Applicant: QUALCOMM Incorporated, San Diego, CA (US)

(72) Inventors: Hee Jun Park, San Diego, CA (US); Yiran Li, San Diego, CA (US); Jewon Kang, Seoul (KR)

(21) Appl. No.: 14/855,359

(22) Filed: Sep. 15, 2015

Related U.S. Application Data
(63) Continuation of application No. 14/327,271, filed on Jul. 9, 2014.
(60) Provisional application No. 61/919,513, filed on Dec. 20, 2013.

(51) Int. Cl. H04N 19/156; H04N 19/107; H04N 19/182; H04N 19/154; H04N 19/196

(52) U.S. Cl. CPC H04N 19/156; H04N 19/154; H04N 19/196; H04N 19/182; H04N 19/107

(57) ABSTRACT

In an example, a method includes encoding video data at a first video quality using an encoding parameter, and determining an operating characteristic of one or more components of an electronic device configured to record the video data. The method also includes adjusting the encoding parameter based at least in part on the determined operating characteristic and while maintaining the first video quality, and encoding the video data at the first video quality using the adjusted encoding parameter.

This application is a continuation of U.S. application Ser. No. 14/327,271, filed Jul. 9, 2014, and claims the benefit of U.S. Provisional Application No. 61/919,513, filed Dec. 20, 2013, the entire contents of which are incorporated herein by reference.

### TECHNICAL FIELD

This disclosure relates to techniques for rendering video data with a computing device.

### BACKGROUND

Mobile devices may take the form of mobile telephones, tablet computers, laptop computers, portable computers with wireless communication cards, personal digital assistants (PDAs), digital cameras, video gaming devices, portable media players, flash memory devices with wireless communication capabilities, wireless communication devices including so-called “smart” phones and “smart” pads or tablets, e-readers, or other of a wide variety of other types of portable devices. Mobile devices are becoming increasingly powerful with the addition of high-power processors, the capability to process media content, and the ability to interact with networks in the cloud. The advancements in processing power and capabilities of devices may also cause the devices to consume power and/or generate heat.

### SUMMARY

The techniques of this disclosure include determining one or more operating characteristics of an electronic device and determining an encoding parameter for encoding video data with the device based at least in part on the determined operating characteristic of the device. In some examples, the encoding parameter may be selected to maintain the quality of encoded video while also keeping the device operating below a particular temperature and/or power threshold.

In an example, a method includes encoding video data at a first video quality using an encoding parameter, determining an operating characteristic of one or more components of an electronic device configured to record the video data, adjusting the encoding parameter based at least in part on the determined operating characteristic and while maintaining the first video quality, and encoding the video data at the first video quality using the adjusted encoding parameter.

In another example, an electronic device includes one or more components configured to record video data and one or more processors. The one or more processors are configured to encode video data at a first video quality using an encoding parameter, determine an operating characteristic of the one or more components of the electronic device configured to record the video data, adjust the encoding parameter based at least in part on the determined operating characteristic and while maintaining the first video quality, and encode the video data at the first video quality using the adjusted encoding parameter.

In another example, an apparatus includes means for encoding video data at a first video quality using an encoding parameter, means for determining an operating characteristic of one or more components of an electronic device configured to record the video data, means for adjusting the encoding parameter based at least in part on the determined operating characteristic and while maintaining the first video quality, and means for encoding the video data at the first video quality using the adjusted encoding parameter.

In another example, a non-transitory computer-readable medium has instructions stored thereon that, when executed, cause one or more processors of an electronic device to encode video data at a first video quality using an encoding parameter, determine an operating characteristic of one or more components of an electronic device configured to record the video data, adjust the encoding parameter based at least in part on the determined operating characteristic and while maintaining the first video quality, and encode the video data at the first video quality using the adjusted encoding parameter.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 illustrates example devices that may implement techniques of this disclosure.

FIG. 2 is a block diagram illustrating an example video encoding and decoding system that may implement the techniques of this disclosure.

FIG. 3 is a block diagram illustrating an example video encoder that may implement the techniques of this disclosure.

FIG. 4 is a block diagram illustrating an example video decoder that may implement the techniques of this disclosure.

FIG. 5 is a block diagram showing an example of a device that may be configured to implement the techniques of this disclosure.

FIG. 6 is a conceptual diagram of a group of pictures (GOP) in a video sequence.

FIG. 7 is a conceptual diagram illustrating a search region in a reference picture.

FIGS. 8A and 8B are conceptual diagram illustrating intra-prediction and intra-prediction modes, respectively.

FIG. 9 illustrates an example process for encoding video data according to aspects of this disclosure.

FIG. 10 illustrates another example process for encoding video data according to aspects of this disclosure.

FIG. 11 illustrates an example process for transcoding encoded video data according to aspects of this disclosure.

FIG. 12 illustrates an example process for determining a power consumption of a device, according to aspects of this disclosure.

FIG. 13 illustrates an example graph for determining an encoding parameter, according to aspects of this disclosure.

FIG. 14 is a flow chart illustrating an example process for encoding video data, according to aspects of this disclosure.

### DETAILED DESCRIPTION

The techniques of this disclosure include determining one or more operating characteristics of an electronic device and determining an encoding parameter for encoding video data with the device based at least in part on the determined operating characteristic of the device. In some examples, the encoding parameter may be selected to maintain the quality of encoded video while also keeping the device operating below a particular temperature and/or power threshold.

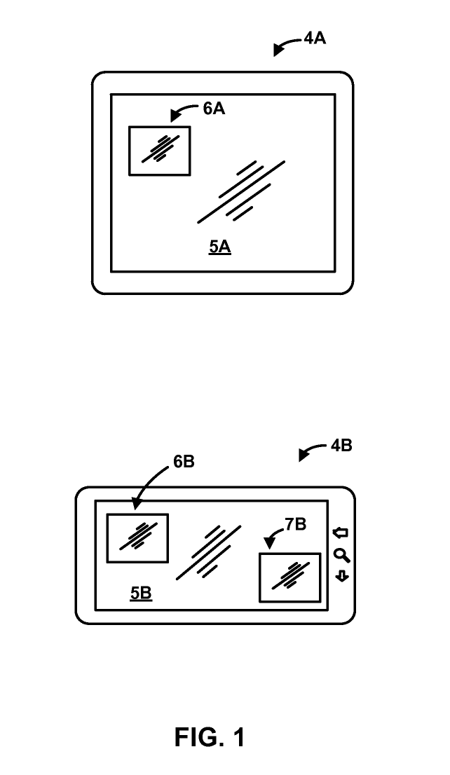

FIG. 1 illustrates example devices that may implement techniques of this disclosure. In the example of FIG. 1, device 4A includes a display 5A and a picture-in-picture (PIP) window 6A. In addition, device 4B includes a display 5B, a first PIP window 6B and a second PIP window 7B.

Devices 4A and 4B may comprise any of a wide range of devices including, for example, telephone handsets such as so-called “smart” phones, tablet computers, cameras, notebook (i.e., laptop) computers, digital media players, video gaming consoles, video streaming devices, or the like. While devices 4A and 4B may be portable devices, the techniques of this disclosure are not limited in this way. For example, according to other aspects, the techniques may be used with desktop computers, set-top boxes, televisions, or other devices.

Displays 5A and 5B may include a liquid crystal display (LCD), a light emitting diode (LED), an organic light emitting diode (OLED), or any other type of device that can generate intelligible output to a user. In some instances, displays 5A and 5B may be configured as touch-sensitive and/or presence-sensitive displays.

In the example shown in FIG. 1, device 4A includes PIP window 6A and device 4B includes PIP windows 6B and 7B. In some examples, the PIP windows may provide areas for displaying content independently from other content being displayed at displays 5A and 5B. For example, devices 4A and/or 4B may be configured to perform picture-in-picture video recording. In this example, device 4A may record images being displayed at display 5A, while PIP window 6A may display an image of a user capturing the recorded images. In another example, devices 4A and/or 4B may perform video conferencing in conjunction with gaming. For example, device 4B may output a video game to display 5B while also displaying images of a user playing the video game in PIP window 6B and an opponent or companion of the user (also playing the video game) in PIP window 7B. Other examples are also possible.

In some instances, devices 4A and 4B may approach or exceed operating parameters. As an example, as devices 4A and 4B perform an increasing number of functions (e.g., capturing video, rendering graphics, encoding/decoding video, displaying video, or the like), the power consumed by devices 4A and 4B may rise. In addition, in some instances, one or more components of devices 4A and 4B (e.g., a central processing unit (CPU), graphics processing unit (GPU), a camera sub-system, displays 5A and 5B, or the like) may generate heat as a byproduct. Some example functions include wide quad high definition (WQHD) picture-in-picture (PIP) video recording, ultra high definition (UHD) video recording, gaming and video conferencing, high-resolution three-dimensional (3D) graphics rendering, or the like.

Devices 4A and 4B may approach or exceed operating parameters such as a power budget (e.g., 2 watts) or a temperature limit. For example, the temperature of one or more components of devices 4A and 4B may rise above a predetermined operating threshold, particularly in instances in which there is concurrent use of multiple components and/or features of devices 4A and 4B (e.g., such as in UHD video recording, WQHD PIP video recording, or the like).

In some examples, a video encoder and/or video decoder (the combination or which may be referred to as a codec, as described in greater detail below) may contribute to an increase in temperature. For example, encoding video data may consume processing resources and have an associated power draw. In addition, encoding video data may include transferring video data between the codec and a memory of devices 4A and/or 4B (e.g., a volatile memory, such as double data rate (DDR) random access memory (RAM)). Accordingly, the memory usage may also contribute to a rise in power consumption and/or increase in temperature.

Some devices (such as devices 4A and/or 4B) may not have any thermal control for a video codec and/or memory. Moreover, configuring a video encoder to draw less power (e.g., a smaller memory read/write and/or fewer computations) may result in lower image quality in an encoded video file or a larger encoded video file size.

The techniques of this disclosure include determining one or more operating characteristics of an electronic device, such as device 4A or device 4B, and determining an encoding parameter for encoding the video data with the device based at least in part on the determined operating characteristic of the device. The encoding parameter may be selected to maintain the quality of encoded video while also keeping the device operating below a particular temperature or power threshold.

As described herein, the quality of the encoded video may be based on a variety of coding parameters that affect the perceived quality of the encoded video after the video has been decoded and presented (e.g., displayed). For example, the quality of encoded video may be determined based on a frame rate of the encoded data, with a relatively higher temporal frame rate resulting in a relatively higher quality of encoded video data. In another example, the quality of encoded video data may be determined based on a spatial resolution of the encoded video data, with a relatively higher resolution resulting in a relatively higher quality of encoded video data. In still other examples, the quality of encoded video data may be determined based on other factors such as signal-to-noise ratio (SNR), peak signal-to-noise ratio (PSNR), or the like of the encoded video data.

Setting and/or adjusting an encoding parameter while maintaining a particular quality of encoded video data may, in some instances, cause a compression rate (also referred to as a compression ratio) and/or bitrate of the encoded video data to change. For example, a compression rate generally represents how much encoded video data has been compressed relative to the original, un-encoded video data. A bitrate generally represents the number of bits of video data that are included in a bitstream per unit of time. Thus, when a compression rate increases (e.g., the encoded video data is more compressed relative to the original data), the bitrate for the encoded video data typically decreases (e.g., fewer bits are required to represent the encoded video data per unit of time).

Setting and/or adjusting an encoding parameter while maintaining a particular quality of encoded video data may impact a video compression rate (or increase a bitrate). In addition, the compression rate (or bitrate) at which video data is encoded may impact the resulting file size. For example, for a given quantity of video data (e.g., a given number of frames) a relatively higher compression rate (or lower bitrate) may result in a relatively smaller encoded file size, while a lower compression rate (or higher bitrate) may result in a relatively larger encoded file size. Accordingly, setting and/or adjusting an encoding parameter while maintaining a particular quality of video data may also impact a file size of the encoded video data (via the impact on the compression rate/bitrate).

Accordingly, according to aspects of this disclosure, a device may maintain a video quality by adjusting one or more encoding parameters as well as a corresponding adjustment to a compression and/or bitrate. That is, as described in greater detail below, aspects of this disclosure may allow a compression and/or bitrate to fluctuate when adjusting an encoding parameter. Additionally or alternatively, a device may maintain a video quality by adjusting one or more encoding parameters while also fixing one or more other encoding parameters to a predetermined value (or range of values). For example, as described in greater detail below, aspects of this disclosure may include holding some encoding parameters (e.g., a resolution, a frame rate, an SNR/PSNR, or the like) at or near a particular value while adjusting other encoding parameters.

Aspects of this disclosure may include dynamically changing video encoding settings to reduce memory traffic and/or video codec workload. Reducing the memory traffic and/or video codec workload may result in reduced power consumption and/or a reduced temperature in one or more components of the device, and may be referred to herein as a “low power mode.” For example, device 4A or device 4B may use the techniques to balance power consumption and/or heat generation with video compression. That is, as a video compression rate increases, the computational demand on a video codec of device 4A or device 4B also increases. In addition, as described in greater detail below, read/write accesses to memory of device 4A or device 4B may also increase.

According to aspects of this disclosure, device 4A or device 4B may control one or more encoding parameters of a codec to control the power consumption of and/or heat generated by device 4A or device 4B and leverage a trade-off between power usage (by the video codec, memory, or other components of the device) and a video compression rate. For example, device 4A or device 4B may adjust one or more encoding parameters to reduce the power consumption of and/or heat generated by device 4A or device 4B. To maintain a particular quality of video data, device 4A or device 4B may adjust one or more encoding parameters while also fixing one or more other encoding parameters (e.g., a resolution, a frame rate, an SNR/PSNR, or the like) to a predetermined value (or range of values) and allow the compression rate to decrease, thereby increasing the size (e.g., in bytes) of the encoded video file (e.g., relative to video data encoded with initial encoding parameters at a higher compression rate).

As an example for purposes of illustration, device 4A or device 4B may initially set one or more video encoding parameters based on a temperature of one or more components of device 4A or device 4B exceeding a predetermined temperature threshold. Additionally or alternatively, device 4A or device 4B may dynamically control the video encoding parameters based on a temperature of one or more components of device 4A or device 4B exceeding a predetermined temperature threshold. That is, device 4A or device 4B may adjust the video encoding parameters during operation (recording and/or encoding) based on a temperature of one or more components of the device rising above a temperature threshold. Setting and/or adjusting the video encoding parameters may help to lower the temperature of the components of device 4A or device 4B.

In another example, device 4A or device 4B may initially set (and/or adjust during coding) one or more video encoding parameters based on a number of pixels being processed by an encoder of device 4A or device 4B. For example, as the number of pixels that are encoded per second increases, the temperature of the codec and/or other components of the device (such as memory) may also increase. Thus, the number or pixels that are processed may act as a proxy for heat generation and/or power consumption of the device. According to aspects of this disclosure, device 4A or device 4B may initially set one or more video encoding parameters based on a number of pixels to be processed (e.g., encoded) in a particular duration exceeding a pixel processing threshold. Additionally or alternatively, device 4A or device 4B may dynamically control the video encoding parameters based on the number of pixels being processed exceeding a predetermined pixel processing threshold. That is, device 4A or device 4B may adjust the video encoding settings during operation (recording and/or encoding) based on the number of pixels being encoded from rising above a pixel processing threshold. Again, setting and/or adjusting the video encoding parameters may help to lower the temperature of the components of device 4A or device 4B.

During recording and/or coding, the codec may draw power from an internal power source, such as a battery of device 4A or device 4B. Thus, the battery may be considered to be configured to record video data, in the sense that the battery is needed for video recording. According to aspects of this disclosure, device 4A or device 4B may initially set one or more video encoding parameters based on a status of a power source of device 4A or device 4B. For example, device 4A or device 4B may initially set one or more video encoding parameters based on an amount of power that is available in a power source. Additionally or alternatively, device 4A or device 4B may dynamically control the video encoding parameters based on the power being depleted below a predetermined threshold and/or faster than a predetermined rate. That is, device 4A or device 4B may adjust the video encoding settings during operation (recording and/or encoding) based on the power being depleted below a predetermined threshold and/or faster than a predetermined rate. Setting and/or adjusting the video encoding parameters may help to prevent the power source from being depleted by the codec.

In some examples, device 4A or device 4B may use any combination of example thresholds described above (e.g., temperature, pixel processing, power source status, or the like). As noted above, as a video compression rate increases, the computational demand on a video codec of device 4A or device 4B also increases. Conversely, reducing the video compression rate may result in a power and/or thermal savings. However, reducing the video compression rate may result in encoded video files having a relatively larger file size (versus an encoded file coded at a higher compression rate).

The techniques of this disclosure include transcoding an encoded video file from a lower compression rate to a higher compression rate, thereby reducing the size of the encoded video file. The techniques may be used in conjunction with the video encoder parameter control described above to reduce a size of a file encoded in a low power mode, e.g., with a relatively low compression rate to save power and/or reduce temperature. For example, in instances in which device 4A or device 4B generates encoded video files using low power mode, device 4A or device 4B may transcode the video files to a smaller file size (e.g., using higher compression rate).

In some examples, according to aspects of this disclosure, the transcoding may be performed upon a predetermined transcoding condition being satisfied. For example, transcoding may itself consume power. Accordingly, device 4A or device 4B may initiate transcoding when the transcoding operations are least likely to have an adverse effect on the power and/or temperature of the device. The condition for initiating transcoding may also be referred to as a “trigger” or “triggering condition.” For example, device 4A or device 4B may initiate transcoding with device 4A or device 4B are idle (one or more components are not operational/not being used by a user), when a battery source of device 4A or device 4B has more than a predetermined amount of charge remaining, and/or when device 4A or device 4B are connected to an external power source, such as by an alternating current AC adapter. In such examples, the transcoding initialization condition may be at least one of a predetermined idle duration of the device, a battery state of a battery of device 4A or device 4B (e.g., a remaining charge exceeding a predetermined level, charge dissipating slower than a predetermined rate, or the like), or a power source status of the device.

As described in greater detail below, according to aspects of this disclosure, device 4A or device 4B may also terminate transcoding upon a predetermined transcoding termination condition (or “trigger”) being satisfied. In some examples, the transcoding termination condition may include at least one of a change in state from an idle state to an active state, a state of battery of device 4A or device 4B (e.g., a remaining charge falling below a predetermined level, charge dissipating faster than a predetermined rate, or the like), or a change in power source status from an external power source to an internal power source.

According to still other aspects of this disclosure, one or more power models may be used to evaluate a chipset level or system level power impact of video encoding settings and determine parameters for lower power consumption. For example, as noted above, memory usage and an associated power draw may be impacted based on video encoding parameters (e.g., read/write access to memory). As another example, encoded video may be stored to a local storage location (e.g., a non-volatile memory, such as a removable secure digital (SD) memory or other memory (including non-removable memory) or may be transmitted to a remote memory (e.g., cloud-based storage) using wireless communication techniques. The power draw associated with storing encoded data may depend on the size of the video files, the storage location, and the components involved in storing the data (e.g., a memory bus, a wireless transmitter, or the like).

According to aspects of this disclosure, one or more power models may be used to determine an estimated power consumption, which may be used to control video encoding parameters. Example power models include a video encoder power model, a memory power model, a local storage power model, and a remote storage power model (which may vary based on the transmission technique associated with the remote storage). In an example, when power consumption is estimated to be high, the techniques may be used to reduce the power consumption of the video codec.

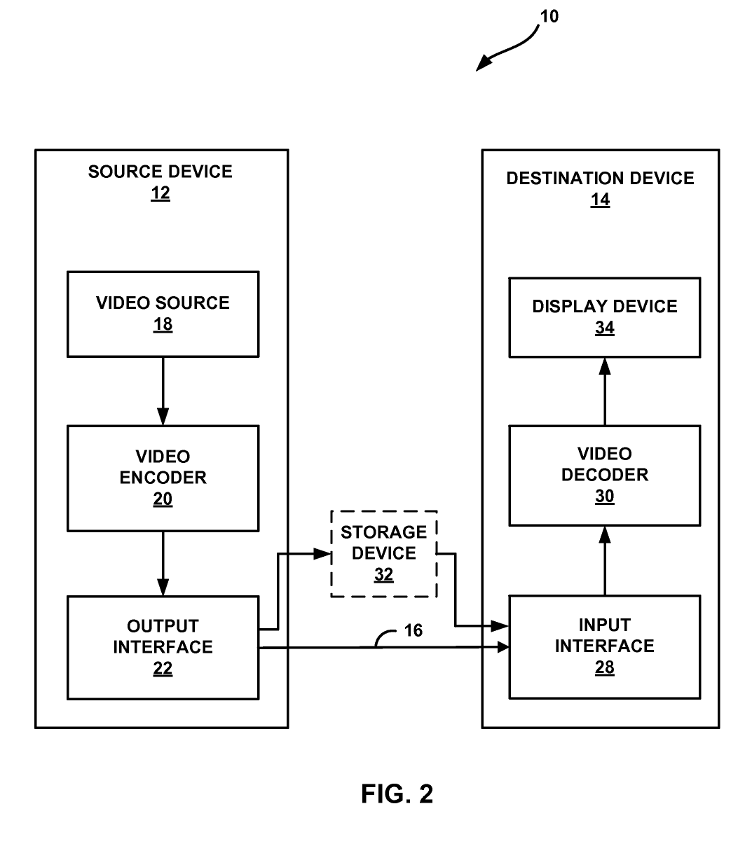

FIG. 2 is a block diagram illustrating an example video encoding and decoding system 10 that may utilize the techniques of this disclosure. As shown in FIG. 2, system 10 includes a source device 12 that provides encoded video data to be decoded at a later time by a destination device 14. In particular, source device 12 provides the video data to destination device 14 via a link 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

Alternatively, encoded data may be output from output interface 22 to a storage device 32. Similarly, encoded data may be accessed from storage device 32 by input interface. Storage device 32 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 32 may correspond to a file server or another intermediate storage device that may hold the encoded video generated by source device 12. Destination device 14 may access stored video data from storage device 32 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive.

Destination device 14 may access stored video data from storage device 32 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 2, source device 12 includes video source 18, video encoder 20, and output interface 22. Destination device 14 includes input interface 28, video decoder 30, and display device 34. In accordance with this disclosure, video encoder 20 of source device 12 may be configured to apply the techniques for video coding. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 2 is merely one example. The techniques of this disclosure may be performed by any digital video encoding and/or decoding device. Although generally the techniques of this disclosure are performed by a video encoding device, the techniques may also be performed by a video encoder/decoder, typically referred to as a “CODEC.” Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 12. The encoded video data may be transmitted directly to destination device 14 via output interface 22 of source device 20. The encoded video data may also (or alternatively) be stored onto storage device 32 for later access by destination device 14 or other devices, for decoding and/or playback.

Destination device 14 includes an input interface 28, a video decoder 30, and a display device 31. In some cases, input interface 28 may include a receiver and/or a modem. Input interface 28 of destination device 14 receives the encoded video data over link 16. The encoded video data communicated over link 16, or provided on storage device 32, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 34 may be integrated with, or external to, destination device 14. In some examples, destination device 14 may include an integrated display device and also be configured to interface with an external display device. In other examples, destination device 14 may be a display device. In general, display device 34 displays the decoded video data to a user, and may comprise any of a variety of display devices such as a liquid crystal display (LCD), a plasma display, an organic light emitting diode (OLED) display, or another type of display device.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined video encoder/decoder (CODEC). A device including video encoder 20 and/or video decoder 30 may comprise an integrated circuit, a microprocessor, and/or a wireless communication device, such as a cellular telephone.

Although not shown in FIG. 2, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, or other protocols such as the user datagram protocol (UDP).

Video encoder 20 and video decoder 30 may operate according to a video compression standard, such as the ITU-T H.264 standard, alternatively referred to as MPEG-4, Part 10, Advanced Video Coding (AVC), or extensions of such standards. The ITU-T H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March, 2005, which may be referred to herein as the H.264 standard or H.264 specification, or the H.264/AVC standard or specification. Other examples of video compression standards include MPEG-2 and ITU-T H.263.

The JCT-VC recently developed the HEVC standard. While the techniques of this disclosure are not limited to any particular coding standard, the techniques may be relevant to the HEVC standard, e.g., for UHD video encoding/decoding. In general, with respect to HEVC, a picture may be divided into a sequence of treeblocks or largest coding units (LCU) that include both luma and chroma samples. Syntax data within a bitstream may define a size for the LCU, which is a largest coding unit in terms of the number of pixels. A slice includes a number of consecutive treeblocks in coding order. A video picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs.

In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU.

TUs may include coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following transformation, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Video encoder 20 may then scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan.

After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

Video encoder 20 may further send syntax data, such as block-based syntax data, picture-based syntax data, and group of pictures (GOP)-based syntax data, to video decoder 30, e.g., in a picture header, a block header, a slice header, or a GOP header. The GOP syntax data may describe a number of pictures in the respective GOP, and the picture syntax data may indicate an encoding/prediction mode used to encode the corresponding picture.

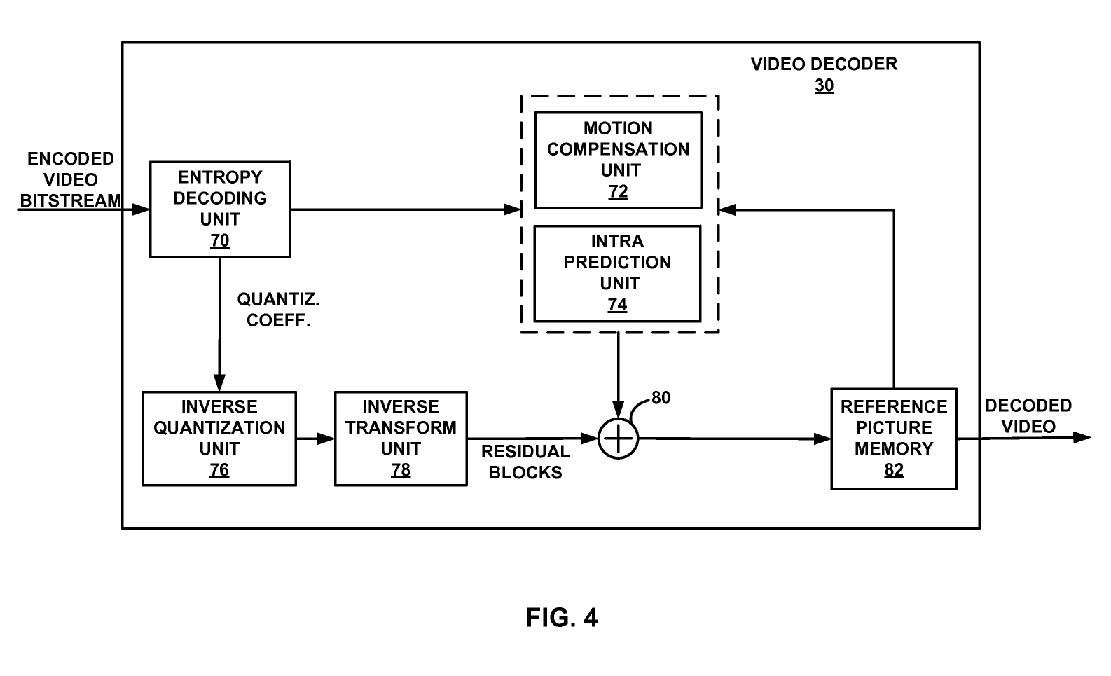

Video decoder 30, upon receiving the coded video data, may perform a decoding pass generally reciprocal to the encoding pass described with respect to video encoder 20, as described in greater detail, for example, with respect to FIG. 4 below.

The techniques of this disclosure include determining one or more operating characteristics of an electronic device, such source device 12, and determining an encoding parameter for encoding the video data with and encoder of the device based at least in part on the determined operating characteristic of the device. The encoding parameter may be selected (e.g., initially selected or adjusted during video coding) to maintain the quality of encoded video. In some examples, source device 12 may maintain quality by maintaining one or more encoding parameters (e.g., a resolution, a frame rate, an SNR/PSNR, or the like) at a particular value or relatively small range of values. As noted above, setting and/or adjusting an encoding parameter while maintaining a particular quality of encoded video data may impact a video compression rate (or increase a bitrate). According to aspects of this disclosure, source device 12 may set and/or adjust an encoding parameter without maintaining a particular compression rate and/or bitrate.

Source device 12 may, in some examples, use the techniques to balance power consumption and/or heat generation with video compression. For example, according to aspects of this disclosure, source device 12 may control one or more encoding parameters of video encoder 20 to control the power consumption of and/or heat generated by source device 12. In some examples, source device 12 may initially control one or more video encoding parameters of video encoder 20 based on a temperature of one or more components of source device 12 exceeding a predetermined temperature threshold. In other examples, source device 12 may initially control one or more video encoding parameters of video encoder 20 based on a power source being depleted beyond a predetermined threshold or faster than a predetermined rate. In still other examples, source device 12 may initially control one or more video encoding parameters of video encoder 20 based on the number of pixels being encoded exceeding a pixel processing threshold. Controlling the video encoding parameters may help to lower the temperature of the components of device 4A or device 4B and/or slow the depletion of a power source of device 4A or device 4B.

While the examples above describe setting initial encoding parameters (e.g., set prior to encoding), according to aspects of this disclosure, source device 12 may additionally or alternatively dynamically adjust video encoding parameters of video encoder 20 during encoding (e.g., in real time or near real time). In addition, source device may use any combination of conditions (e.g., temperature, pixel processing rate, battery status, or the like) as a basis for controlling parameters of video encoder 20.

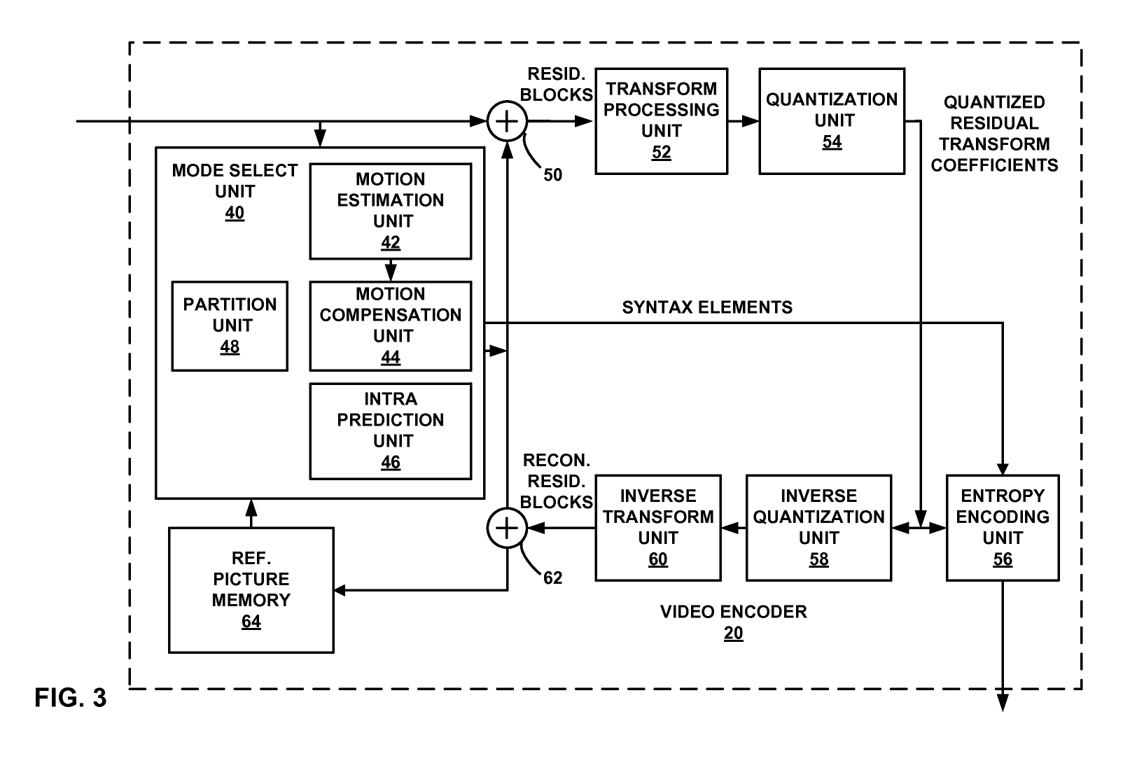

FIG. 3 is a block diagram illustrating an example of a video encoder 20 that may use techniques of this disclosure. The video encoder 20 will be described in the context of HEVC coding for purposes of illustration, but without limitation of this disclosure as to other coding standards or methods that may also be used with the techniques of this disclosure.

Video encoder 20 may perform intra- and inter-coding of video blocks within video slices. Intra-coding relies on spatial prediction to reduce or remove spatial redundancy in video within a given video picture. Inter-coding relies on temporal prediction to reduce or remove temporal redundancy in video within adjacent pictures of a video sequence. Intra-mode (I mode) may refer to any of several spatial based compression modes. Inter-modes, such as uni-directional prediction (P mode) or bi-prediction (B mode), may refer to any of several temporal-based compression modes.

As shown in FIG. 3, video encoder 20 receives a current video block within a video picture to be encoded. In the example of FIG. 3, video encoder 20 includes mode select unit 40, reference picture memory 64, summer 50, transform processing unit 52, quantization unit 54, and entropy encoding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 3) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video picture or slice to be coded. The picture or slice may be divided into multiple video blocks. Motion estimation unit 42 and motion compensation unit 44 perform inter-predictive coding of the received video block relative to one or more blocks in one or more reference pictures to provide temporal compression. Intra-prediction unit 46 may alternatively perform intra-predictive coding of the received video block relative to one or more neighboring blocks in the same picture or slice as the block to be coded to provide spatial compression. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a picture or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference picture. Mode select unit 40 also provides syntax elements, such as motion vectors, intra-mode indicators, partition information, and other such syntax information, to entropy encoding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video picture relative to a predictive block within a reference picture (or other coded unit) relative to the current block being coded within the current picture (or other coded unit).

A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists.

Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

Video encoder 20 forms a residual video block by subtracting the prediction data from mode select unit 40 from the original video block being coded. Summer 50 represents the component or components that perform this subtraction operation.

Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used. In any case, transform processing unit 52 applies the transform to the residual block, producing a block of residual transform coefficients. The transform may convert the residual information from a pixel value domain to a transform domain, such as a frequency domain.

Transform processing unit 52 may send the resulting transform coefficients to quantization unit 54. Quantization unit 54 quantizes the transform coefficients to further reduce bitrate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks.

Following the entropy coding by entropy encoding unit 56, the encoded bitstream may be transmitted to another device (e.g., video decoder 30) or archived for later transmission or retrieval. Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the pictures of reference picture memory 64. Motion compensation unit 44 may also apply one or more interpolation filters to the reconstructed residual block to calculate sub-integer pixel values for use in motion estimation.

Summer 62 adds the reconstructed residual block to the motion compensated prediction block produced by motion compensation unit 44 to produce a reconstructed video block for storage in reference picture memory 64. The reconstructed video block may be used by motion estimation unit 42 and motion compensation unit 44 as a reference block to inter-code a block in a subsequent video picture.

According to aspects of this disclosure, video encoder 20 may be configured to set and/or adjust one or more encoding parameters for encoding video data based at least in part on an operating characteristic of the device. For example, according to aspects of this disclosure, one or more encoding parameters of video encoder 20 may be controlled to regulate the power consumption of and/or heat generated by video encoder 20 and/or a device containing video encoder 20.

In some examples for purposes of illustration, one or more encoding parameters of video encoder 20 may be set and/or adjusted based on a temperature of video encoder 20 and/or other components of a device containing video encoder 20, a pixel processing rate of video encoder 20, a status of a power source of a device containing video encoder 20, or the like.

According to aspects of this disclosure, example encoding parameters may include a B-frame parameter, a search region parameter, and a prediction mode parameter. Such parameters may be controlled individually or in combination. In addition, it should be understood, however, that these examples are provided merely for purposes of explanation and illustration, and the techniques may be used in conjunction with other encoding parameters that may impact a power draw and/or thermal characteristics of video encoder 20 or other components of a device containing video encoder 20 (e.g., a size of CUs or PUs, a quantization rate, other prediction limitations, a limitation on the number of pictures and/or amount of data stored to reference picture memory 64, or the like).

In an example, according to aspects of this disclosure, video encoder 20 may enable or disable B-frames in video coding based on an operating characteristic of video encoder 20 and/or a device containing video encoder 20. Disabling B-frames may, for example, reduce an amount of memory traffic required for encoding, thereby reducing the power consumption of video encoder 20 and/or memory utilized by video encoder 20 during coding. To disable B-frames, video encoder 20 may adjust motion estimation unit 42 and motion compensation unit 44 such that only one reference picture list is used during inter-predictive coding. Restricting video encoder 20 to a single reference picture list may reduce the computational resources and/or memory access required to perform motion estimation/compensation relative to using two lists.

In another example, video encoder 20 may restrict and/or adjust a search region for performing inter-prediction. For example, limiting a search region for performing inter-prediction may reduce the number of computations associated with finding a predictive block that closely matches the block currently being coded (e.g., referred to as a “best match”), thereby reducing the power consumption of video encoder 20. In addition, a relatively smaller search region may reduce the amount of data accessed from memory, thereby further reducing power consumption, as noted above. Video encoder 20 may limit the search region by restricting the areas of other pictures or slices in which motion estimation unit 44 may locate a predictive block (e.g., as identified by a motion vector).

In still another example, video encoder 20 may restrict and/or adjust a prediction mode. For example, video encoder 20 may determine a set of available prediction modes. In some examples, video encoder 20 may enable or disable inter-prediction, as performed by motion estimation unit 42 and motion compensation unit 44, entirely. In other examples, video encoder 20 may reduce the number of intra-modes applied by intra-prediction unit 46. Reducing the number and/or type of prediction modes that are available may reduce the power consumption via a reduced computational load and/or a reduction in memory access. For example, by reducing the number and/or type of prediction modes that are available, video encoder 20 may perform relatively fewer rate-distortion optimizations, which may result in reduced power consumption via a reduced computational load and/or a reduction in memory access.

Adjusting the parameters of video encoder 20 described above may impact the compression rate and/or bitrate of the encoded video data. For example, applying restrictions (e.g., such as restricting the use of B-frames, the number of prediction modes, the number of search regions, or the like) at video encoder 20 may result in encoded video files having a relatively larger file size, relative to video files encoded without the restrictions. The techniques of this disclosure include transcoding an encoded video file from a lower compression rate to a higher compression rate, thereby reducing the size of the encoded video file. In some instances, video encoder 20 may be used for transcoding video data. For example, in instances in which encoded video files are generated using low power mode, video encoder 20 may transcode the larger video files to a smaller file size (e.g., using higher compression rate and/or lower bitrate).

In some examples, according to aspects of this disclosure, the transcoding may be performed upon a predetermined transcoding condition being satisfied. In some examples, a device containing video encoder 20 may initiate transcoding when one or more components of the device are idle, when a battery source of the device has more than a predetermined amount of charge remaining, when the device is connected to a power source, or the like. In such examples, the triggering condition may be at least one of a predetermined idle duration of the device, a battery state of a battery of the device (e.g., charge remaining, charge dissipation rate, or the like), or a power source status of the device.

In addition, according to aspects of this disclosure, the transcoding may be terminated upon a predetermined termination condition being satisfied. The termination condition may include, as non-limiting examples, a change in state of a device that includes video encoder 20 from an idle state to an active state, or a change in power source status of a device that includes video encoder 20 from an external power source to an internal power source of the device.

FIG. 4 is a block diagram illustrating an example of video decoder 30 that may implement the techniques of this disclosure. In the example of FIG. 4, video decoder 30 includes an entropy decoding unit 70, motion compensation unit 72, intra prediction unit 74, inverse quantization unit 76, inverse transformation unit 78, reference picture memory 82 and summer 80.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to motion compensation unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current picture.

When the video picture is coded as an inter-coded (i.e., B or P) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference picture lists, List 0 and List 1, using default construction techniques based on reference pictures stored in reference picture memory 82.

Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice or P slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de-quantizes, the quantized transform coefficients provided in the bitstream and decoded by entropy decoding unit 70. The inverse quantization process may include use of a quantization parameter QP_{Y} calculated by video decoder 30 for each video block in the video slice to determine a degree of quantization and, likewise, a degree of inverse quantization that should be applied.

Inverse transform unit 78 applies an inverse transform, e.g., an inverse DCT, an inverse integer transform, or a conceptually similar inverse transform process, to the transform coefficients in order to produce residual blocks in the pixel domain. The inverse transform may be reciprocal to the forward transform applied during video encoding (e.g., by video encoder 20).

After motion compensation unit 72 generates the predictive block for the current video block based on the motion vectors and other syntax elements, video decoder 30 forms a decoded video block by summing the residual blocks from inverse transform unit 78 with the corresponding predictive blocks generated by motion compensation unit 72. Summer 80 represents the component or components that perform this summation operation.

If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given picture are then stored in reference picture memory 82, which stores reference pictures used for subsequent motion compensation. Reference picture memory 82 also stores decoded video for later presentation on a display device, such as display device 34 of FIG. 2.

According to aspects of this disclosure, video decoder 30 may decode the video data encoded by video encoder 20 (as described above with respect to FIGS. 2 and 3). In instances in which video is transcoded, video decoder 30 may be used to decode the video during the transcoding process.

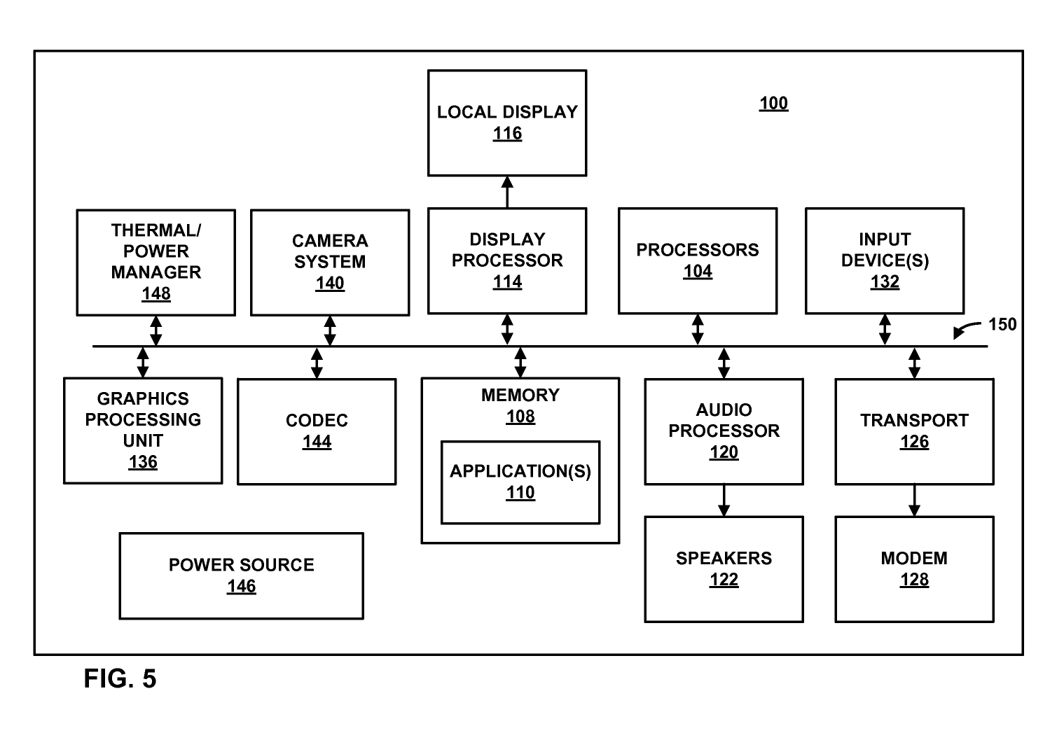

FIG. 5 is a block diagram showing one example of a device 100 that may be configured to implement the techniques of this disclosure. In some examples, one more components shown and described with respect to device 100 may be incorporated in device 4A and/or device 4B (FIG. 1).

In the example shown in FIG. 5, device 100 includes one or more processors 104, memory 108 storing one or more applications 110, display processor 114, local display 116, audio processor 120, speakers 122, transport unit 126, wireless modem 128, input devices 132, camera system 140, video encoder/video decoder (codec) 144, a power source 146, and thermal/power manager 148. Other examples may include more or fewer components than those shown in FIG. 5. In addition, while certain components are described separately for purposes of discussion, it should be understood that some components shown and described with respect to FIG. 5 may be highly integrated or combined to form a single component.

Each of components 104, 108, 114, 120, 126, 132, 136, 140, 144, and 148 may be interconnected (physically, communicatively, and/or operatively) for inter-component communications via communication channels 150. In some examples, communication channels 150 may include a system bus, network connection, inter process communication data structure, or any other channel for communicating data.

One or more processors 104 may be capable of processing instructions stored in memory 108. One or more of processors 104 may form a central processing unit (CPU) for device 100. Processors 104 may include, for example, one or more microprocessors. DSPs, ASICs, FPGAs, discrete logic, or any combinations thereof. In some examples, processors 104 may include fixed function logic and/or programmable logic, and may execute software and/or firmware. When the techniques are implemented partially in software, a device may store instructions for the software in a suitable, non-transitory computer-readable medium and execute the instructions in hardware using one or more processors to perform the techniques of this disclosure.

Memory 108 of FIG. 5 may comprise any of a wide variety of volatile or non-volatile memory, including but not limited to random access memory (RAM) such as synchronous dynamic random access memory (SDRAM), read-only memory (ROM), non-volatile random access memory (NVRAM), electrically erasable programmable read-only memory (EEPROM), magnetic random access memory (MRAM), FLASH memory, and the like. Memory 108 may comprise a computer-readable storage medium for storing audio/video data, as well as other kinds of data.

In some examples, memory 108 may store applications 110 that are executed by processor 104 as part of performing the various techniques described in this disclosure. Memory 108 may also store certain audio/video (A/V) data for presentation by device 100. For example, memory 108 may store an entire A/V file, or may comprise a smaller buffer that simply stores a portion of an A/V file, e.g., streamed from another device or source. In any event, memory 108 may buffer A/V data before the data is presented by device 100. Memory 108 may also store video data (by codec, described below 144) while the video data is being encoded, as well as after an encoded video file has been generated.

In some examples, device 100 may locally process and display A/V data. In particular, display processor 114 may form a portion of a platform for processing video data to be displayed on local display 116. In this regard, display processor 114 may include a codec (as described above with respect to processors 104). Display 116 may include a liquid crystal display (LCD), light emitting diode (LED), organic light emitting diode (OLED), or any other type of device that can generate intelligible output to a user. In addition, audio processor 120 may process audio data for output on one or more speakers 122.

Transport unit 126 may process encoded A/V data for a network transport. For example, encoded A/V data may be processed by processors 104 and encapsulated by transport unit 126 into Network Access Layer (NAL) units for communication across a network. The NAL units may be sent by modem 128 to another device via a network connection. In this regard, modem 128 may operate according to any number of communication techniques including, e.g., orthogonal frequency division multiplexing (OFDM) techniques, time division multi access (TDMA), frequency division multi access (FDMA), code division multi access (CDMA), or any combination of OFDM, FDMA, TDMA and/or CDMA, WiFi, Bluetooth, Ethernet, the IEEE 802.11 family of standards, or any other wireless or wired communication technique. In some instances, modem 128 of device 100 may receive encapsulated data packets, such as NAL units, and send the encapsulated data units to transport unit 126 for decapsulation. For instance, transport unit 126 may extract data packets from the NAL units, and processors 104 can parse the data packets to extract the user input commands.

One or more input devices 132 may be configured to receive input from a user through tactile, audio, or video feedback. Examples of input device 132 include a touch and/or presence sensitive screen, a mouse, a keyboard, a voice responsive system, a microphone or any other type of device for detecting a command from a user.

Graphics processing unit (GPU) 136 represents one or more dedicated processors for performing graphical operations. That is, for example, GPU 136 may be a dedicated hardware unit having fixed function and/or programmable components for rendering graphics and executing GPU applications. In some examples, GPU 136 may also include a DSP, a general purpose microprocessor, an ASIC, an FPGA, or other equivalent integrated or discrete logic circuitry. Although GPU 136 is illustrated as a separate unit in the example of FIG. 5, in some examples, GPU 136 may be integrated with one or more other processors 104 (such as a CPU) into a single unit.

Camera system 140 may include an image processor, image sensor, as well as a number of other components for capturing images. Camera system 140 may include one or more components for so-called camera phones or video phones. In some instances, camera system 140 may operate in combination with GPU 136 to generate computer graphics-based data as the source video, or a combination of live video, archived video, and/or computer-generated video. The captured, pre-captured, or computer-generated video may be encoded by a video encoder (described above).

Codec 144 may be configured to encode and/or decode A/V data for transport, storage, and display. For example, codec 144 may include one or both of video encoder 20 and video decoder 30 and may operate as a video encoder or a video decoder, either of which may be integrated as part of a combined video encoder/decoder (codec), as described above with respect to FIGS. 2-4. In some instances, codec 144 may operate according to a video compression standard, such as the ITU-T H.264 standard, alternatively referred to as MPEG-4, Part 10, Advanced Video Coding (AVC), or extensions of such standards. Other examples of video compression standards include MPEG-2 and ITU-T H.263 and the High Efficiency Video Coding (HEVC) standard.

Thermal/power manager 148 may manage one or more components of device 100 to keep the one or more components operating at or below one or more operating characteristic targets. In an example, the operating characteristic target may be a thermal target indicative of an operating temperature of device 100, such that adjusting the at least one operating parameter of the device to produce the operating characteristic target comprises adjusting the at least one operating parameter of the device to maintain a temperature of the device equal to or less than the thermal target. In another example, the operating characteristic target comprises a power target indicative of an amount of power consumed by operating the device, such that adjusting the at least one operating parameter of device 100 to produce the operating characteristic target comprises adjusting the at least one operating parameter of the device to maintain a power consumption of the device equal to or less than the power target.

Power source 146 may be any unit that provides power to the components of device 100 by discharging charge that is stored within power source 146. In some examples, power source 146 may be a rechargeable battery and may be coupled to power circuitry. That is, power source 146 may be one or more rechargeable batteries that are tied together in parallel or in series to form a single power source. In another example, power source 146 may comprise one or more single use batteries (e.g., non-rechargeable), one or more capacitors, and/or supercapacitors. In addition, while shown in FIG. 5 as a single power source 146, device 100 may include multiple different power sources 146.

As noted above, power source 146 may include one or more a rechargeable batteries or a non-rechargeable battery or batteries, e.g., one or more primary cell batteries. Examples of power source 146 include, but are not limited to, lead acid batteries, nickel cadmium (NiCad) batteries, nickel metal hydride (NiMH) batteries, lithium ion (Li-ion) batteries, and lithium ion polymer (Li-ion polymer) batteries.

Power source 146 may provide power to one, some, or all of the various components of device 100. Accordingly, power source 146 may be discharged due to the power consumed by the various components of device 100. Due to the discharging, power source 146 may need to be recharged or replaced periodically to ensure that power source 146 does not fully drain. Power source 146 may include a charging unit to facilitate charging of power source 146. For example, power source 146 may be rechargeable via an external power source including, for example, an alternating current (AC) wired power source and/or an electromagnetic power source. Thus, in some instances, power source 146 may include an AC adapter or charging coil for inductive energy transfer.

According to aspects of this disclosure, thermal/power manager 148 may set and/or adjust one or more encoding parameters implemented by codec 144 to encode video data based at least in part on an operating characteristic of device 100. Thermal/power manger 148 may control the one or more encoding parameters of codec 144 to regulate the power consumption of and/or heat generated by codec 144, memory 108, or other components of device 100. For example, thermal/power manager 148 may take a proactive approach to regulation by initially setting the one or more operating parameters and/or a reactive approach to regulation by adjusting/modifying the one or more operating parameters during coding.

In an example, thermal/power manager 148 may set and/or adjust one or more encoding parameters of codec 144 based on a temperature of codec 144, memory 108, or other components of device 100 (e.g., a CPU of device 100, GPU 136, transport unit 126 and/or modem 128, or a variety of other components). In another example, thermal/power manager 148 may set and/or adjust one or more encoding parameters of codec 144 based on a pixel processing rate of codec 144. In still another example, thermal/power manager 148 may set and/or adjust one or more encoding parameters of codec 144 based on a status of a power source 146 (e.g., a rate of discharge of power source 146, a capacity of power source 146, a remaining charge of power source 146, a charging status of power source 146 or the like).

As noted above with respect to the example of FIG. 2, example encoding parameters may include a B-frame parameter, a search region parameter, and a prediction mode parameter. For example, thermal/power manager 148 may enable or disable B-frame coding in codec 144 based on an operating characteristic of device 100. In another example, thermal/power manager 148 may restrict and/or adjust a motion search region for performing inter-prediction in codec 144. In still another example, thermal/power manger 148 may restrict and/or adjust a prediction mode, such as an intra-prediction mode, used by codec 144. Adjusting these or other parameters may help thermal/power manger 148 to reduce the power consumption via a reduced computational load on codec 144, a reduction in reads/writes to memory 108, and/or the like.

In some instances, encoding parameters of codec 144 may be referred to as “knobs.” For example, a number of“knobs” may be adjusted to provide a particular codec 144 configuration having particular processing parameters/capabilities. Example knobs and associated encoding parameters are shown in Table 1 below:

TABLE 1

| Knobs | Possible settings | |
|---|---|---|
| B-frame | Enable | Disable |
| Block search | Large | Small |
| region size | | |
| (Pixel search | (Inter-frame) | (Intra-frame) |
| mode) | | |
| Other knobs | . . . | . . . |
| Effects | higher power consumption, | lower power consumption, |
| | more computation, more | less computation, less |
| | memory read/write traffic, | memory read/write traffic, |
| | smaller bitrate (file size) | larger bitrate (file size) |
| | of encoded data (better | of encoded data (worse |
| | image quality for the same | image quality for the |
| | file size) | same file size) |

While reference is made to B-frames, search regions, and prediction modes, as noted above, it should be understood that thermal/power manager 148 may control other operating parameters of codec 144 to achieve a reduction in power and/or thermal energy. Accordingly, the techniques may be used to provide a relatively longer full performance duration until thermal mitigation is initiated, as well as a longer battery life. In addition, while the size of the encoded video file may be altered, the techniques do not impact the quality of the encoded data.

According to some aspects of this disclosure, thermal/power manger 148 may use one or more power models to evaluate a power impact of video encoding settings. Thermal/power manager 148 may determine parameters of codec 144 based at least in part on these power models.

For example, as noted above, memory usage and an associated power draw may be impacted based on video encoding parameters (e.g., read/write access to memory). As another example, device 100 may store encoded video from codec 144 to memory 108 or may transmit the encoded video data to a remote memory (e.g., cloud-based storage) via transport unit 126 and/or modem 128. The power draw associated with storing encoded data may depend on the size of the video files, the storage location, and the components involved in storing the data (e.g., a memory bus, a wireless transmitter, or the like).

According to aspects of this disclosure, thermal/power manger 148 may use one or more power models to determine an estimated power consumption, and may use the estimated power consumption to control video encoding parameters of codec 144. Example power models include a power model for codec 144, a power model for memory 108, and a power model for transport unit 126 and/or modem 128. In an example, when the estimated power draw exceeds a predetermined threshold, thermal/power manager may implement settings and/or adjustments to encoding parameters of codec 144 to reduce the power consumption of device 100.

In one example for purposes of illustration, a user may specify a usage requirement. For example, the user may specify that the device 100 must remain operable for a certain length of time (e.g., one hour of video recording and/or encoding). In this example, thermal/power manger 148 may determine a state of charge of power source 146 and an estimated power draw of device 100 (e.g., using one or more power models) and may set and/or adjust encoding parameters of codec 144 in an attempt to satisfy the user specified duration. In other examples, the power parameters need not be user specified. That is, power usage data may be stored to memory 108 and used to maximize the life of power source 146.

According to aspects of this disclosure, thermal/power manger 148 may set and/or adjust the encoding parameters while maintaining a particular video quality. For example, some techniques for controlling a temperature of device 100 may include processor throttling, a reduction in frame rate, and/or a reduction in resolution. However, such techniques typically result in a loss of quality in the encoded video data.

According to aspects of this disclosure, thermal/power manger 148 may set and/or adjust the encoding parameters while maintaining a particular video quality. As noted above, setting and/or adjusting an encoding parameter while maintaining a particular quality of encoded video data may, in some instances, cause a compression rate (also referred to as a compression ratio) and/or bitrate of the encoded video data to change. In some examples, thermal/power manger 148 may retain the quality of encoded video data by allowing the compression rate and/or bitrate of the encoded video data to rise or fall as needed.

The compression rate (or bitrate) at which video data is encoded may impact the resulting file size. For example, for a given quantity of video data (e.g., a given number of frames) a relatively higher compression rate (or lower bitrate) may result in a relatively smaller encoded file size, while a lower compression rate (or higher bitrate) may result in a relatively larger encoded file size. Accordingly, setting and/or adjusting an encoding parameter while maintaining a particular quality of video data may also impact a file size of the encoded video data (via the impact on the compression rate/bitrate).

According to aspects of this disclosure, thermal/power manager 148 may initiate a transcoding process of one or more video files to transcode the video files from a first file size to a second, smaller file size (e.g., having an increased compression rate). For example, transcoding may include applying an additional coding loop after coding content at a particular level (e.g., bitrate). The transcoding may be carried out by codec 144 or another component of device 100.

In some examples, according to aspects of this disclosure, thermal/power manger 148 may initiate transcoding upon a predetermined transcoding condition being satisfied. For example, thermal/power manager 148 may initiate transcoding by codec 144 when one or more components of device 100 are idle, such as processors 104, display processor 114/display 116, or the like.

In another example, thermal/power manager 148 may initiate transcoding when power source 146 exceeds a predetermined remaining power threshold (e.g., power source 146 contains a predetermined remaining charge). In another example, thermal/power manager 148 may initiate transcoding when power source 146 is discharging slower than a predetermined rate. In another example, thermal/power manager 148 may initiate transcoding when power source 146 is connected to an external power source (e.g., an AC power source). In still another example, thermal/power manager 148 may initiate transcoding upon being directed to transcode by a user of device 100. Other examples are also possible.

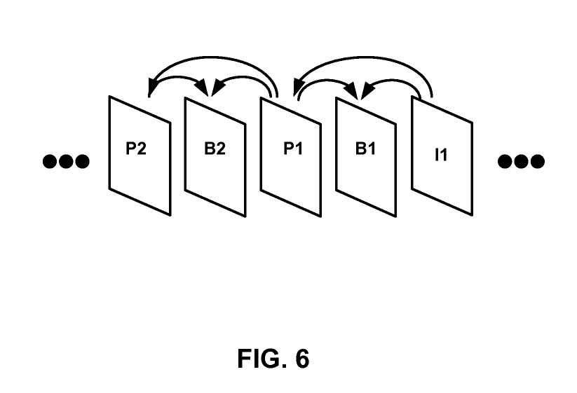

FIG. 6 is a conceptual diagram of at least a portion of a group of pictures (GOP). In general, predictions are indicated by arrows, where the pointed-to picture uses the point-from object for prediction reference. The example of FIG. 6 illustrates an intra-coded picture I1 (that is, an 1-frame), two pictures inter-coded in one direction P1 and P2 (that is, as P-frames) and two pictures inter-coded in multiple directions B1 and B2 (that is, as B-frames).

In some examples, a video encoder (such as video encoder 20 and/or codec 144) may determine (e.g., in firmware) whether to code a frame as a B-frame or P-frame prior to coding the frame. When a picture is encoded as a P-frame, the video encoder may search for predictive data from one reference list (e.g., RefPicList0 or RefPicList1). However, when a picture is encoded as a B-frame, the video encoder searches for predictive data in two directions, i.e., in two reference picture lists. Searching for predictive data in additional locations results in additional memory reads, which increases memory bandwidth usage.

According to aspects of this disclosure, a power manager of a device (such as thermal/power manager 148 of device 100 (FIG. 5) may enable or disable the use of B-frames in video coding based on an operating characteristic of the device. In this regard, when B-frame coding is disabled, pictures B1 and B2 of FIG. 6 may be coded as P-frames or I-frames. Accordingly, the video encoder performs the motion search for inter-prediction data in one direction, i.e., with one reference picture list, instead of two. Disabling B-frames may, for example, reduce an amount of memory traffic required for encoding (e.g., reads from and writes to memory), thereby reducing the power consumption of the device.

In some examples, as noted above, disabling B-frames may result in video files having a lower compression rate. As an example, disabling B-frames may result in an increased bitrate of approximately 15% for the same quality of encoded video data.

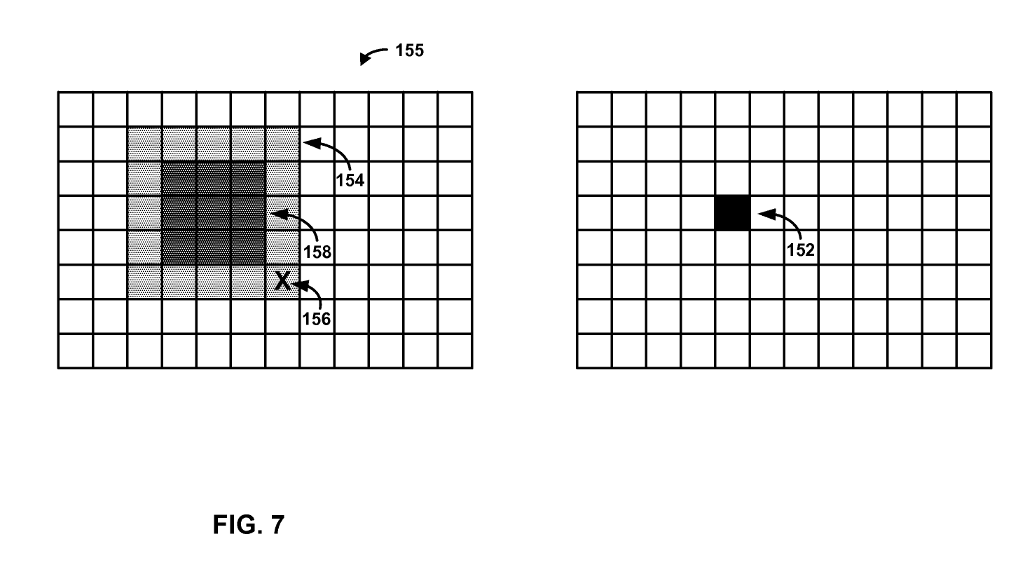

FIG. 7 is a conceptual diagram illustrating a block currently being coded 152 and a search region 154 (all shaded boxes) in a reference picture 155. For example, search region 154 is a region in reference picture 155 that a video encoder, such as video encoder 20 (FIGS. 2 and 3) and codec 144, may locate a predictive block for inter-coding current block 152. Search region 154 may be a region of reference pictures 155 in which the video encoder is permitted to locate and identify a best match 156 (marked with an “X”) for inter-predicting the current block. The video encoder may generate a residual between best match 156 and current block 152. In some examples, a video encoder may determine (e.g., in firmware) how large of a search region to use for the motion search (e.g., in terms of number of pixels and/or number of blocks) prior to coding the frame.

According to aspects of this disclosure, a power manager of a device (such as thermal/power manager 148 of device 100 (FIG. 5)) may adjust search region 154 based on an operating characteristic of the device. For example, the power manager may reduce search region 154 from a first size (including all of the shaded blocks) to a second, smaller size 158 (including the darker shaded blocks and referred to as a “reduced search region”) based on an operating characteristic of the device (e.g., when a power consumption and/or temperature of the device exceeds a predetermined threshold). In general, as noted above with respect to FIG. 3, the search region may be a region for motion search. For example, search region 154 may be used to identify a block that closely matches the block currently being coded (current block 152), so that the identified block may be used as a reference block during motion estimation/compensation. In some examples, areas (e.g., blocks) of search region 154 may be evaluated relative to current block 152 based on a sum of squared differences (SSD), sum of absolute differences (SAD) or other metrics to identify a reference block. Reducing the size of the search region may, for example, reduce an amount of memory traffic required for encoding, e.g., reads from memory to locate a reference block for inter-prediction. In addition, computations associated with block matching may be reduced. Accordingly, the techniques may reduce the power consumption of the device.

However, reducing the search region may also result in a lower probability of locating a best match for inter-coding the current block. For example, as shown in FIG. 7, reduced search region 158 no longer includes best match 156. Accordingly, the video encoder may select a block from reduced search region 158 that does not match current block 152 as well as best match 156, thereby increasing the size of the residual and decreasing coding efficiency. Accordingly, while the techniques may save memory bandwidth (thereby lowering the power draw and/or temperature), the savings may be achieved at the cost of lower compression efficiency. As described herein, the video encoder may transcode data at an appropriate time to regain the lost compression.

In some instances, reducing the search region, as shown in FIG. 7, may provide relatively significant memory bandwidth savings for pictures having a large size (e.g., pictures having a horizontal resolution of 4000 pixels, referred to as “4K”) and a video encoder having relatively limited on-chip memory. In some examples, an average of a 3% rate increase may result if the search region is reduced from ±256×±128 to ±112×±64 (in pixels).

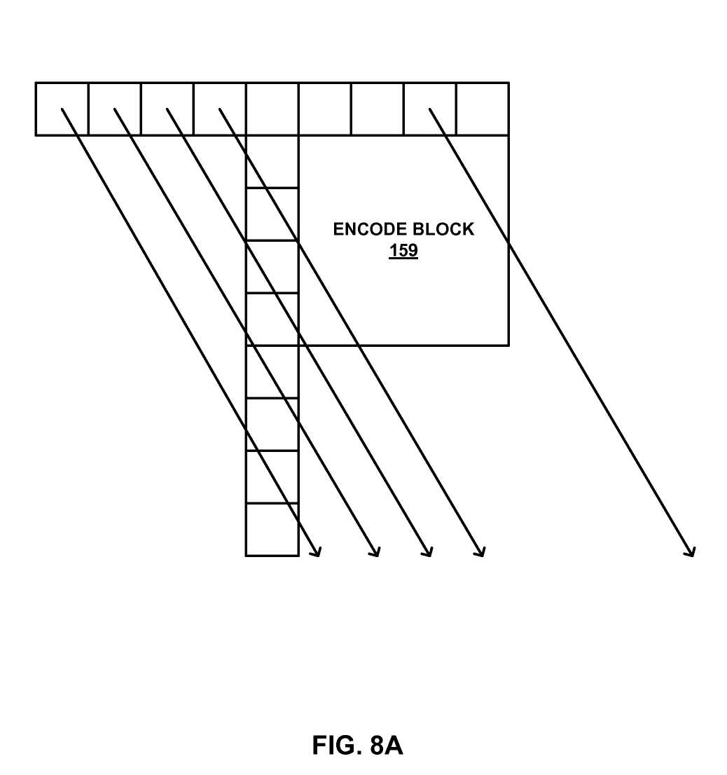

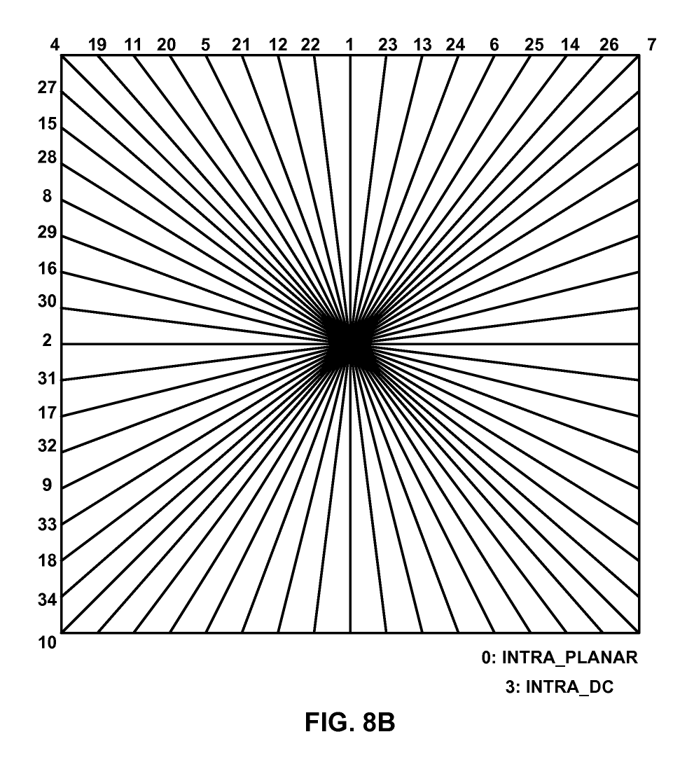

FIGS. 8A and 8B are conceptual diagram illustrating intra-prediction and intra-prediction modes, respectively. In intra-prediction, as shown in FIG. 8A, a block of video data 159 (“encode block”) is coded relative to information of neighboring pixels of the same slice or picture. That is, a video encoder (such as video encoder 20 and/or codec 144) may determine a residual based on differences between samples of the block being coded and neighboring samples.

Pixels may be intra-predicted in a variety of different ways. FIG. 8B is a diagram illustrating intra prediction modes used in HEVC. FIG. 8B generally illustrates the prediction directions associated with various directional intra-prediction modes available for intra-coding in HEVC. In the current HEVC, for the luma component of each Prediction Unit (PU), an intra-prediction method is utilized with 33 directional (angular) prediction modes (indexed from 2 to 34), DC mode (indexed with 1) and Planar mode (indexed with 0), as shown in FIG. 8B.

In the Planar mode (indexed with 0), prediction is performed using a so-called “plane” function to determine predictor values for each of the pixels within a block of video data, e.g., PU. In the DC mode (indexed with 1), prediction is performed using an averaging of pixel values within the block to determine predictor values for each of the pixels within the block. In a directional prediction mode, prediction is performed based on a neighboring block's reconstructed pixels along a particular direction (as indicated by the mode), where such reconstructed pixels serves as intra-prediction reference samples. In general, the tail end of the arrows shown in FIG. 8B represents a relative one of neighboring pixels from which a value is retrieved, while the head of the arrows represents the direction in which the retrieved value is propagated to form a predictive block.

For HEVC intra prediction modes, a video encoder and/or video decoder generates a pixel specific predictor value for each pixel in the PU using the various modes discussed above, e.g., by using neighboring samples of the PU for modes 2 to 34. A video encoder (e.g., encoder 20 implemented in codec 144) determines residual values for the video block based on the differences between the actual depth values and the predictor values for the pixels of the block, and provides the residual values to video decoder (e.g., decoder 30 implemented in codec 144). The video encoder transforms the residual values and quantizes the transform coefficients, and may also entropy encode the quantized transform coefficients. A video decoder, after entropy decoding, inverse quantizing, and inverse transforming, determines reconstructed values for the pixels of the block by adding the residual values to the predictor values.

In some examples, a video encoder may determine (e.g., in firmware) a prediction mode (e.g., an intra-prediction mode or an inter-prediction mode) prior to coding the frame. As noted above, inter-prediction, in which a reference picture is searched for a predictive block, may require relatively high memory bandwidth due to fetching and reading reference pictures from memory. However, as noted above, intra-prediction only uses neighboring pixels of the picture currently being coded as a reference. Accordingly, there may be no need to read reference data from an external memory in the case of intra-coding.

According to aspects of this disclosure, a power manager of a device (such as thermal/power manager 148 of device 100 (FIG. 5) may select a prediction mode based on an operating characteristic of the device. For example, the power manager may reduce the number of available prediction modes that are available, including disabling an inter-prediction mode and/or one or more of the intra-modes (e.g., as described above with respect to FIG. 8B). Reducing the prediction modes that are available may, for example, reduce an amount of memory traffic and/or computational resources required for encoding, thereby reducing the power consumption of the device.

However, reducing the type and/or number of prediction modes that are available may also result in lower compression efficiency. Accordingly, while the techniques may save bandwidth and/or computations, the savings may be achieved at the cost of lower compression efficiency. For example, switching from an inter-prediction mode to an intra-prediction mode may reduce memory bandwidth relatively significantly, but a bitrate of the encoded video data may be increased relatively substantially. As described herein, the video encoder may transcode data at an appropriate time to regain the lost compression.

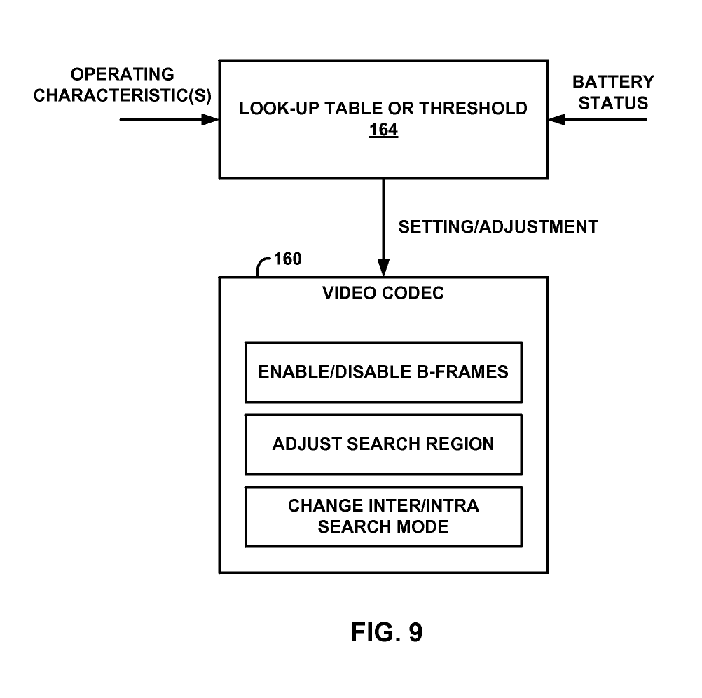

FIG. 9 illustrates an example process for encoding video data according to aspects of this disclosure. For example, FIG. 9 illustrates an example in which one or more operating parameters of a video codec 160 (which may be configured similarly to or the same as video encoder 20 and/or codec 144) may be initially set, e.g., prior to encoding, based on one or more operating characteristics of a device (such as device 100).

Operating characteristics may include, as examples, a frame rate of the video data being coded (e.g., in frames per second (FPS), a resolution of the video data being coded, a pixel processing rate of the video data being coded, or any combination thereof. In some examples, the pixel processing rate may be determined by multiplying the resolution of pictures in a sequence by a frame rate of the sequence (e.g., recording resolution*FPS information). While shown separately in the example of FIG. 9 for purposes of illustration, operating characteristics may also include a battery status of a battery of the device (e.g., a capacity of the battery, a remaining charge of the battery, a charging status of the battery, or the like).

In the example of FIG. 9, the device may use a look-up table or other listing or models of parameters/thresholds 164 to determine the operating parameters of video codec 160. In some examples, the listing of parameters may be included in and/or accessed by a driver of the device. Hence, look-up table or threshold box 164 represents the use of a look-up table (LUT) or other comparison function to determine the operating parameters of video codec 160. For example, a thermal and/or power manager (e.g., such as thermal/power manager 148) may incorporate LUT or threshold box 164 to determine setting/adjustments for video codec 160. That is, the thermal and/or power manager may receive operating characteristics and or battery status information and use the data as index values to obtain settings and/or adjustments for video codec 160.

As noted elsewhere in this disclosure, the settings and/or adjustments (e.g., encoding parameters) may be selected to attain an optimal tradeoff between compression rate and power consumption. That is, the techniques may be used to lower the power consumption and/or heat generated by the device, but may result in an increase to the size of encoded files.

Example encoding parameters that may be determined for video codec 160 include whether to enable or disable B-frames, whether to adjust a search region associated with an inter-prediction mode, and whether to enable one or more prediction modes. The techniques of this disclosure are not limited to these example parameters. Adjustment of other encoding parameters is also possible (e.g., a size of blocks, a quantization rate, other prediction limitations, a limitation on the number of pictures and/or amount of data stored to a decoded picture buffer, or the like).

In some examples, the encoding parameters may be static. In other examples, the encoding parameters may be dynamic. That is, the encoding parameters of look-up table 164 may change based on the operating conditions of the device. In an example for purposes of illustration, assume that the table 164 includes a first set of parameters for maintaining video codec 160 below a predetermined operating temperature and/or power consumption threshold. Assume further that codec 160 encodes video data using the parameters but exceeds the predetermined operating temperature and/or power consumption threshold. In this example, after encoding the file but prior to encoding a subsequent file, table 164 may be updated with operating parameters that may achieve a more aggressive power savings.

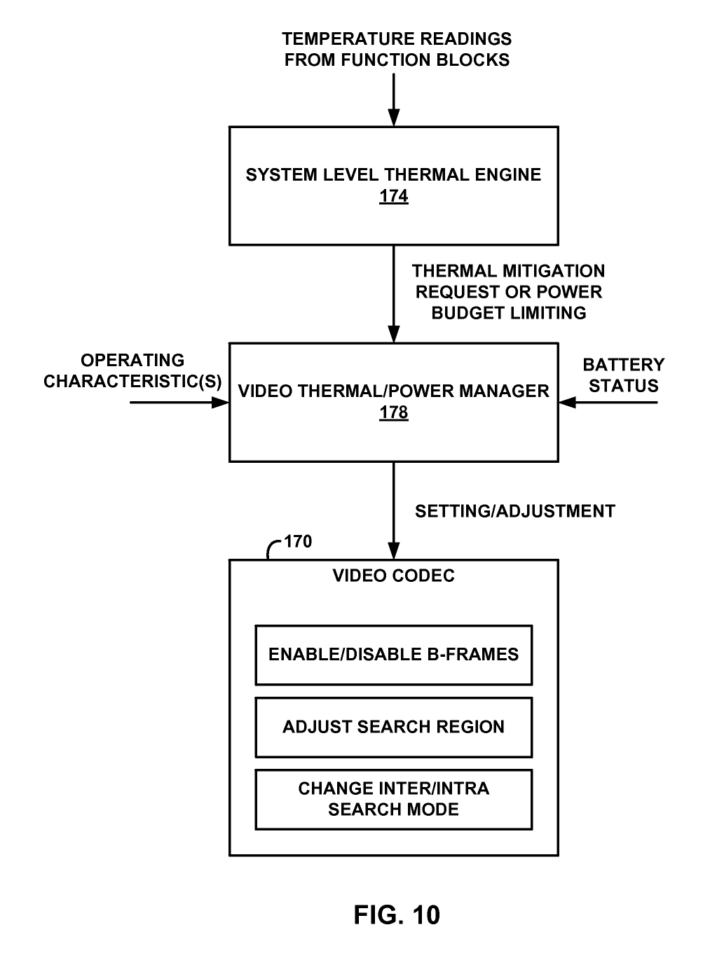

FIG. 10 illustrates another example process for encoding video data according to aspects of this disclosure. For example, FIG. 10 illustrates an example in which one or more operating parameters of a video codec 170 (which may be configured similarly to or the same as video encoder 20 and/or codec 144) may be dynamically changed during encoding based on one or more operating characteristics of a device (such as device 100).

Operating characteristics may include, as examples, a frame rate of the video data being coded (e.g., in frames per second (FPS), a resolution of the video data being coded, a pixel processing rate of the video data being coded, a battery status of a battery of the device (e.g., a capacity of the battery, a remaining charge of the battery, a charging status of the battery, or the like), or any combination thereof. In some examples, the pixel processing rate may be determined by multiplying the resolution of pictures in a sequence by a frame rate of the sequence (e.g., recording resolution*FPS information).

In the example of FIG. 10, a system level thermal engine 174 may receive temperature readings from one or more function blocks of the device. The system level thermal engine may issue a thermal mitigation request (to reduce the temperature of the device) or a power budget limiting request (to reduce power consumption by the device) to a video thermal/power manager 178 (which may correspond to thermal/power manager 148 (FIG. 5)).

Video thermal/power manager 178 may determine settings and/or adjustments for operating parameters of video codec 170 to satisfy the thermal mitigation request or power budget limiting request, and may be based on the operating characteristics (including battery status) described above. In some examples, video thermal/power manager 178 may be included in and/or accessed by a driver of the device. Again, as noted elsewhere in this disclosure, the techniques may be used to lower the power consumption and/or heat generated by the device, but may result in an increase to the size of encoded files.

Example encoding parameters that video thermal/power manager 178 may adjust include whether to enable or disable B-frames, whether to adjust a search region associated with an inter-prediction mode, and whether to enable one or more prediction modes. The techniques of this disclosure are not limited to these example parameters. Adjustment of other encoding parameters is also possible (e.g., a size of blocks, a quantization rate, other prediction limitations, a limitation on the number of pictures and/or amount of data stored to a decoded picture buffer, or the like).

In some examples, system thermal engine 174 and video thermal power manager 178 may operate together to control the power draw and/or temperature of a device including video codec 170. For example, system thermal engine 174 and video thermal power manager 178 may operate based on a predetermined priority to control the power draw and/or temperature of the device including video codec 170. In some instances, video thermal power manager 178 may be initially responsible for adjusting encoding parameters while maintaining video data of a particular quality, in accordance with the techniques of this disclosure. If the techniques applied by video thermal power manager 178 do not reduce the power consumption and/or temperature of the device below a particular threshold, system level thermal engine 174 may apply other techniques (e.g., processor throttling, a reduction in FPS, a reduction in resolution, or the like) to further lower the power draw and/or temperature of the device including video codec 170 at the expense of video quality.

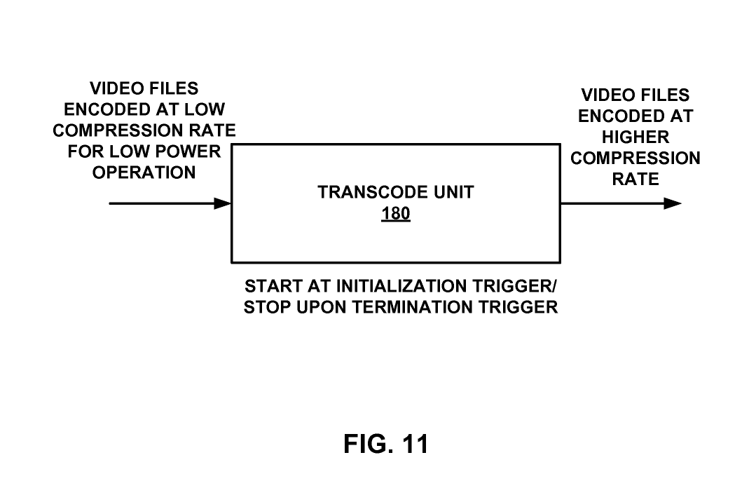

FIG. 11 illustrates an example process for transcoding encoded video data according to aspects of this disclosure. The example of FIG. 11 includes transcoding unit 180. Transcoding unit 180 may be a standalone unit of a device (such as device 100), or may be included in a codec (such as codec 144). For example, transcoding unit 180 may represent a second pass through codec 144 using different coding parameters than a first pass).

As noted above, adjusting the parameters described above (or other encoding parameters not specifically described in this disclosure) may impact the bitrate of the encoded video data. According to aspects of this disclosure, transcode unit 180 may transcode one or more video files from a first file size to a second, smaller file size (e.g., having an increased compression rate).

In some examples, according to aspects of this disclosure, transcoding unit 180 may initiate transcoding upon a predetermined transcoding condition being satisfied, e.g., upon an initialization trigger and/or a termination trigger. For example, transcoding unit 180 may initiate transcoding when one or more components of the device containing transcoding unit 180 are idle. In another example, transcoding unit 180 may initiate transcoding when a power source exceeds a predetermined remaining power threshold. In another example, transcoding unit 180 may initiate transcoding when a power source is discharging at slower than a predetermined rate. In another example, transcoding unit 180 may initiate transcoding when a power source is connected to an external power source (e.g., an AC power source). In still another example, thermal/power manager 148 may initiate transcoding upon being directed to transcode by a user of device 100. Other examples are also possible.

Likewise, transcoding unit 180 may stop (terminate) transcoding upon a predetermined termination trigger occurring. In some examples, the transcoding termination trigger may be based on the transcoding initialization trigger. In an example, if transcoding unit 180 initiates transcoding when one or more components of a device are idle (e.g., the trigger is an idle duration), transcoding unit 180 may terminate transcoding when the one or more components of the device become active. In another example, if transcoding unit 180 initiates transcoding when a power source exceeds a predetermined remaining power threshold, transcoding unit 180 may terminate the transcoding process upon the power source having less power than the threshold, and so on.

According to aspects of this disclosure, transcoding 180 may continue to toggle between actively transcoding (upon a trigger being satisfied) and not transcoding (upon a termination condition being satisfied) until a particular file has finished transcoding.

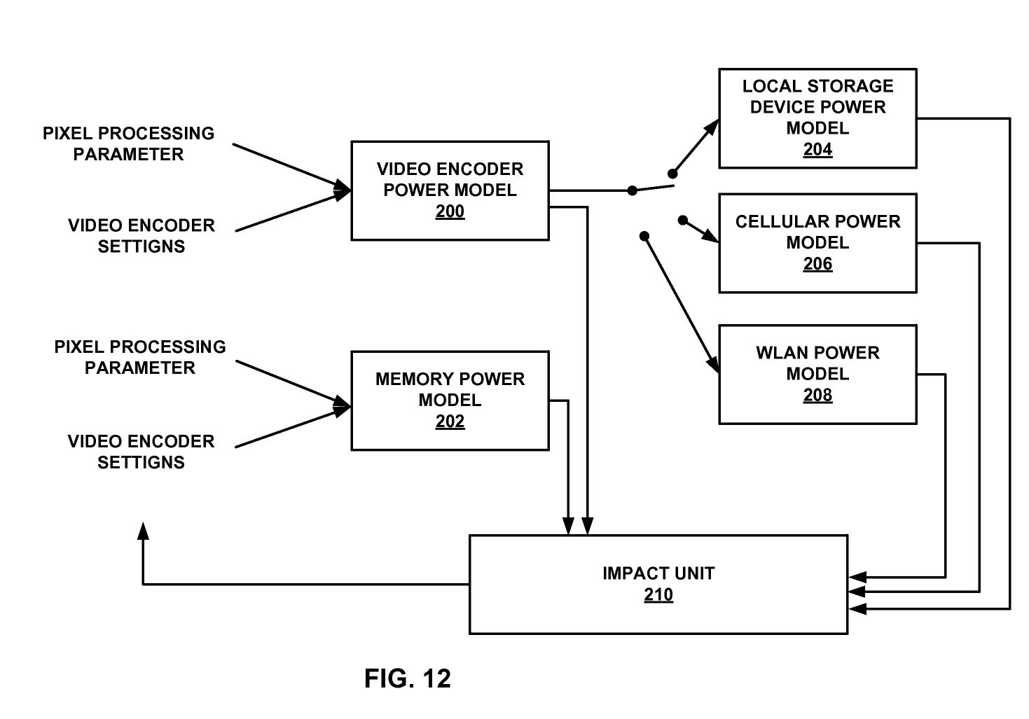

FIG. 12 illustrates an example process for determining a power consumption of a device, such as device 100. For example, as noted above, according to aspects of this disclosure, a device may use one or more power models to evaluate a power impact of video encoding settings. The device may determine one or more encoding parameters of a video encoder (such as video encoder 20 and/or codec 144) based at least in part on these power models. In the example of FIG. 12, power models include a video encoder power model 200, a memory power model 202, a local storage device power model 204, a cellular power model 206 and a wireless local area network (WLAN) power model 208.

Encoded video data may be stored to a variety of locations, each of which may impact the power required to store the video data. For example, a device may store video data to a local storage location (such as memory 108 (FIG. 5) using less power than storing the video data to a remote storage location. A remote storage location may require relatively more power, for example, due to a power draw from a modem or other component for transmitting the data to the remote storage location. According to aspects of this disclosure, a device may use power models 200-208 to evaluate the chipset or system level power impact of video encoding settings, and decide the best settings for lower power consumption.

Video encoder power model 200 may model power usage of a video encoder of the device based on one or more video encoding parameters. For example, video encoder power model 200 may determine a pixel processing parameter of video data being encoded. In some examples, a pixel processing parameter may be a pixel processing rate determined based on a resolution of the video data being encoded multiplied by a frame rate of the video data being coded. For example, a pixel processing rate in pixels per second may be equal to a number of horizontal pixels of a picture multiplied by a number of vertical pixels of a picture multiplied by a frame rate of the video data (FPS). Video encoder power model 200 may also consider a number of other video encoder settings and/or parameters (e.g., a prediction mode, whether B-frames are enabled, a search region, or the like).

Local storage device power model 204 may model power usage of the device when storing encoded video data to local memory (e.g., a memory of the device, such as an SD card). Cellular power model 206 may model power usage of the device when storing encoded video data to a remote memory using a wireless transmission technique such as a cellular or other wireless technique. In some examples, cellular power model 206 may model power of a 3 G/4 G cellular modem, a radio frequency (RF) transmitter, and a power amplifier (PA). WLAN power model 208 may model power usage of the device when storing encoded video data to a remote memory using a wireless transmission technique such as WiFi or other wireless technique. In some examples, WLAN 208 may model power of a WiFi modem and a power amplifier PA.

The power models may be used to determine an estimated impact to the power consumption of the device when a video encoder of the device implements particular video encoding parameters. That is, the power models may be used by an impact unit 210 to determine a total power impact resulting from a particular encoding parameter (or adjustment in the encoding parameter). For example, impact unit 210 may calculate a sum of video encoder power model 200, memory power model 202, local storage device power model 204, cellular power model 206 and wireless local area network (WLAN) power model 208. In some examples, the sum may be a weighted sum, giving more weight to one or more of power models 200-208 than other power models 200-208.

According to aspects of this disclosure, the device may use the power models 200-208 to control video encoding parameters of the video encoder. In an example, when the estimated power draw exceeds a predetermined threshold, the device may implement encoding parameters to reduce the power consumption of the device, as described elsewhere in this disclosure (e.g., disabling B-frames, reducing a search region, disabling one or more prediction modes, or the like).

The techniques described with respect to FIGS. 9-12 (as well as elsewhere in this disclosure) may, in some instances, be carried out using one or more algorithms executed by a device. Example algorithms and details are illustrated in the example of Table 2 below:

TABLE 2

| Cases | Algorithms | Algorithm details |
|---|---|---|
| Video | Algorithm #1A - | During video recording: |

| | | |
|---|---|---|
| recording | Settings dynamically | Thermal engine to |
| | determined depending on | check if |
| | SOC temperature and the | temperature > |
| | previous thermal mitigation | threshold |
| | history at the video record- | If temperature > |
| | ing resolution*FPS | threshold_1 (or |
| | | recording |
| | | resolution*FSP > |
| | | threshold_2 or |
| | | remaining battery < |
| | | threshold_3), video |
| | | thermal power |
| | | manager change the |
| | | video encoder |
| | | settings for low |
| | | power mode. |
| | | Video thermal power |
| | | manager update the |
| | | recording |
| | | resolution*FPS |
| | | threshold_1 for low |
| | | power mode. |
| | | Add the video files in |
| | | a list or mark it for |
| | | transcoding later |
| | | If temperature still is |
| | | higher than the 1st |
| | | threshold after this |
| | | encoding setting |
| | | changes, start the |
| | | conventional |
| | | CPU/GPU throttling, |
| | | too. |

| | |
|---|---|
| Algorithm #1B - | When the video |
| Settings predetermined | recording starts, |

| | |
|---|---|
| (fixed) depending on video | Decide the video |
| recording resolution * FPS | encoder settings |
| (static look-up table or | based on two |
| threshold) | information: |

Resolution*FPS of
the video recording
Static look-up table
or threshold_2

Add the video files in
a list or mark it for
transcoding later

| | | |
|---|---|---|
| Video | Algorithm #2 - | Only when the system |
| transcoding | When system idle and | idle time > threshold_3 |
| | powered by AC adapter | and powered by AC |
| | | adapter: |

| | | |
|---|---|---|
| | | Search video files in |
| | | the list or marked |
| | | video files. |
| | | Transcode them from |
| | | low compression to |
| | | high compression |
| Storing or | Algorithm #3 - | Depending on use |
| transmitting | Optimal setting change | cases, encoded video |
| | depending on output data | stream can be stored |
| | destinations | in local storage |
| | | device (SD card) or |
| | | transmitted to |
| | | network by 3G/4G or |
| | | WiFi. Power model |
| | | can be used to |
| | | evaluate the chipset |
| | | or system level |
| | | power impact of |
| | | video encoding |
| | | settings, and decide |
| | | the best settings for |
| | | lower power |
| | | consumption. |

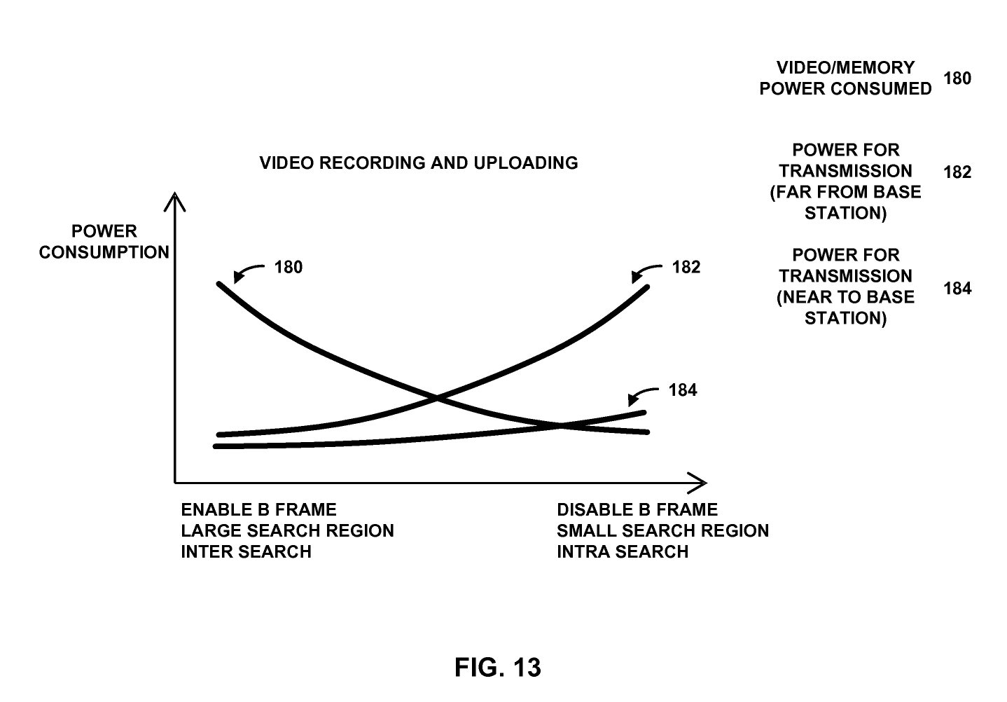

FIG. 13 illustrates an example graph of power consumption versus a number of encoding parameters (e.g., a B-frame encoding parameter (as described above with respect to FIG. 6), a search region parameter (as described above with respect to FIG. 7), and a coding mode parameter (as described above with respect to FIGS. 8A and 8B). The example graph of FIG. 13 may represent an application of cellular power model 206 of FIG. 12 when encoding a given amount of video data.

For example, line 180 represents an amount of power consumed by a video encoder and/or memory of a device when encoding a given amount of video data. Line 182 represents an amount of power needed to wirelessly transmit the encoded video data to a remote storage location, given a relatively long distance between the device and a base station in communication with the device. Line 184 represents an amount of power needed to wirelessly transmit the encoded video data to a remote storage location, given a relatively short distance between the device and a base station in communication with the device.

As illustrated by line 180, power consumption associated with encoding video data is relatively large when B-frames are enabled, a search region is relatively large, and the video data is being encoded with inter-mode. The large power consumption may be due to the computations and data transfer (between the video encoder and memory) when performing the video encoding. When B-frames are disabled, a smaller search region is used, and/or intra-mode coding is performed, the reduction in memory bandwidth and processing may result in a decrease in the amount of power needed to encode the video data.

However, as illustrated by lines 182 and 184, power consumption associated with storing an encoded video file to a remote storage location may increase when B-frames are disabled, a smaller search region is used, or intra-mode coding is performed. For example, when maintaining a particular quality of video data and B-frames are disabled, the size of the encoded video file is increased (relatively to B-frames being enabled). Accordingly, the power consumption associated with transmitting the larger file sizes also increases.

The power associated with transmitting video data may vary based on a number of factors. For example, as shown in FIG. 13, if a device transmitting the encoded video data is located relatively far from a cellular base station (line 182), the power draw of a cellular modem, RF transmitter, and PA may be relatively high to generate a more powerful transmission (TX dBm). If the device is located relatively near a cellular base station (line 184), the power draw of a cellular modem, RF transmitter, and PA may be relatively lower, because less power is needed for transmission (TX dBm).

According to aspects of this disclosure, a device may determine an encoding parameter (e.g., a B-frame encoding parameter, a search region parameter, a coding mode parameter, or the like) based on a model of an amount of power associated with encoding and storing the video data. For example, a device may optimize an encoding parameter adjustment based on a change in power draw resulting from the adjustment.

In an example for purposes of illustration, a device may adjust a video encoding parameter based on an intersection of the power associated with encoding the video data (line 180) with the power associated with storing the video data (line 182 of line 184). By selecting the encoding parameters based on the intersection, the device can locate the optimal power consumption associated with generating the encoded file and transmitting/storing the encoded file.

With respect to lines 182 and 184, for example, a device that is located relatively close to the base station and that, therefore, consumes a relatively small amount of power when transmitting the encoded video data (line 184) may select encoding parameters that result in a relatively large file size. That is, the intersection of lines 180 and 184 is located at the right of the graph, where B-frames are disabled, a search region is small, and/or intra-mode coding is used, which results in a large file size. The large file size is permitted, however, because the amount of power associated with transmitting the encoded file is relatively small and a power savings may be achieved by disabling the encoding parameters.

However, a device that is located relatively far from the base station and that, therefore, consumes a relatively large amount of power when transmitting the encoded video data (line 182) may select encoding parameters that result in a relatively smaller file size. That is, the intersection of lines 180 and 182 is located further to the left of the graph, where B-frames may be enabled, a search region may be larger, and/or inter-mode coding may be used, which results in a smaller file size. The power draw associated with enabling such parameters is permitted, however, because the amount of power associated with transmitting the encoded file is relatively large and a power savings may be achieved by transmitting a smaller file.

The example of FIG. 13 is presented merely for purposes of illustration. Similar graphs may be generated for determining any combination of other operating parameters (e.g., search region, prediction mode, or the like). Table 3, shown below, illustrates the result of disabling B-frames for a given amount of video data captured at 30 FPS and 24 FPS.

| Chipset total | B-Frame | B-frame | Power | Thermal Power |
|---|---|---|---|---|
| power | enabled | disabled | Reduction | Benefit |
| Test Case #1 | 3080 mW | 2960 mW | Δ 120 mW | May maintain the |
| Original: | | | | original FPS level |
| 30 FPS | | | | longer until |
| Test Case #2 | 2840 mW | 2760 mW | Δ 80 mW | thermal mitiga- |
| Original: | | | | tion begins and |
| 24 FPS | | | | FPS is downgraded |

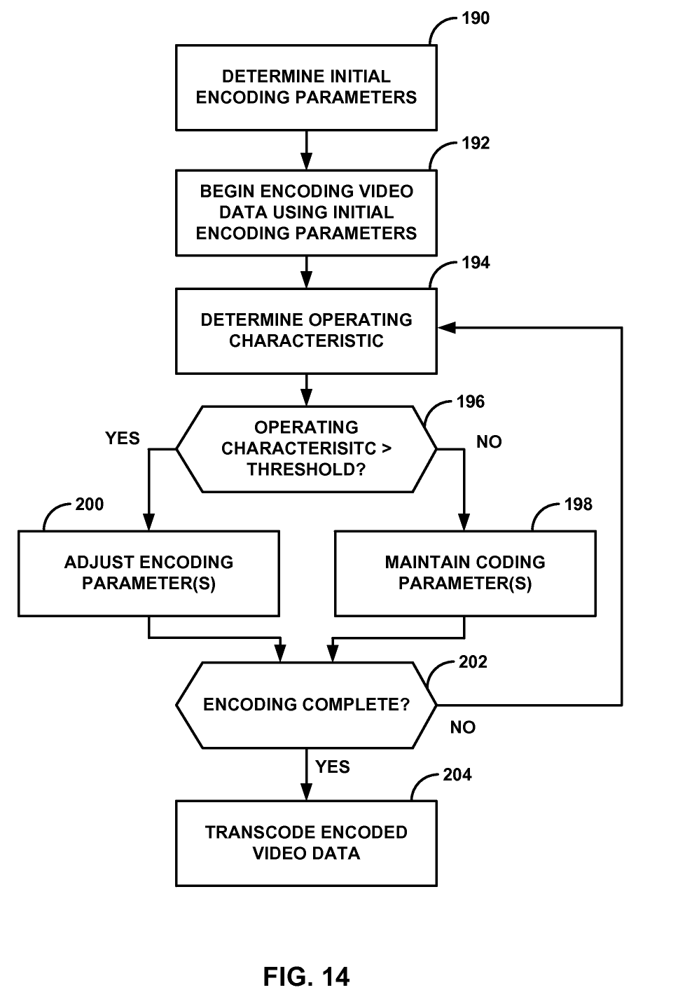

FIG. 14 is a flowchart illustrating an example process for coding video data using a palette coding mode, consistent with techniques of this disclosure. The process of FIG. 14 is explained with respect to a device having a codec, such as device 100 and codec 144 (FIG. 5). However, it should be understood that other devices having one or more other components for video coding may be configured to perform a similar method. Moreover, certain steps in the method may be performed in a different order or in parallel. Likewise, certain steps may be omitted, and other steps may be added, in various examples.

In the example of FIG. 14, device 100 determines a set of initial encoding parameters for codec 144 (190). For example, according to aspects of this disclosure, device 100 may determine initial parameters including a B-frame parameter, a search region parameter, and a prediction mode parameter. Device 100 may select the initial parameters to preemptively control a temperature with which device 100 operates and/or a power draw of device 100 based on an operating characteristic of device 100 and/or codec 144.

For example, device 100 may determine one or more initial encoding parameters based on a pixel processing rate of video data being encoded by codec 144. A high pixel processing rate may be associated with a large computational load and a corresponding high temperature and/or power draw. Accordingly, device may determine one or more encoding parameters to reduce the computational load and/or reduce the memory traffic associated with encoding, thereby preemptively controlling the temperature and/or power draw of device 100. In some examples, device 100 may determine initial encoding parameters based on a look-up table or other listing of parameter values.

Codec 144 may then begin encoding video data using the initial encoding parameters (192). Device 100 may also determine one or more operating characteristics of device 100 (194). For example, device 100 may determine a temperature of one or more components of the device. In another example, device 100 may determine a pixel processing rate for encoding the video data, which may be based on a resolution of the video data and a frame rate of the video data. In still another example, device 100 may determine a status of a battery of the device (e.g., a charge remaining in a battery, whether the battery is currently charged or charging, or the like).

Device 100 may determine whether one or more of the operating characteristics exceed a threshold for the respective characteristics (196). In some examples, device 100 may implement predetermined or dynamic thresholds to maintain device 100 operating below a particular operating temperature and/or slow the depletion of power source 146. In some examples, device 100 may directly determine a temperature threshold. In other examples, device 100 may determine a proxy threshold that may be indicative of a temperature of one or more components of device 100, such as a pixel processing rate threshold. In still other examples, device 100 may determine a power source threshold, such as a threshold that prevents power source 146 from being depleted beyond a predetermined amount or faster than a predetermined rate.

If an operating characteristic is not greater than the respective threshold, device 100 may maintain the encoding parameter without change (198). However, if an operating characteristic is greater than the respective threshold, device 100 may adjust one or more encoding parameters (200). For example, according to aspects of this disclosure, device 100 may adjust a B-frame parameter (e.g., disable the use of B-frames), adjust a search region parameter (e.g., constrain a search area for inter-prediction), adjust a prediction mode parameter (e.g., disable inter-prediction), or any combination thereof. In some examples, device 100 may adjust encoding parameters based on a predetermined hierarchy (e.g., initially adjust a B-frame parameter, followed by a search region parameter, followed by a prediction mode parameter). In other examples, device 100 may selectively adjust more than one encoding parameter at the same time, e.g., according to a parameter adjustment algorithm.

Device 100 may determine whether encoding is complete (202). If encoding is not complete, device 100 may continue to determine one or more operating characteristics (194) to determine whether to adjust encoding parameters. If encoding is complete, device 100 may transcode the encoded video data (204), assuming at least some of the video data was encoded using a low power mode resulting in a relatively large encoded file size.

Accordingly, according to aspects of this disclosure, a method comprises determining an operating characteristic of an electronic device, wherein one or more components of the electronic device are configured to record video data, determining an encoding parameter for encoding the video data based at least in part on the determined operating characteristic of the device, and encoding the video data using the determined encoding parameter.

In an example, the method above, wherein the operating characteristic of the device comprises a resolution for recoding the video data, such that determining the encoding parameter comprises determining the encoding parameter based at least in part on the resolution.

In another example, the method above further includes determining a resolution threshold for recording the video data, and wherein determining the encoding parameter for encoding the video data further comprises determining the encoding parameter based on the resolution for recoding the video data relative to the resolution threshold.

In another example, the method above, wherein the operating characteristic of the device comprises a recording frame rate for recording the video data, such that determining the encoding parameter comprises determining the encoding parameter based at least in part on the frame rate.

In another example, the method above further includes determining a frame rate threshold for recording the video data, and wherein determining the encoding parameter for encoding the video data further comprises determining the encoding parameter based on the frame rate for recording the video data relative to the frame rate threshold.

In another example, the method above, wherein the operating characteristic of the device comprises a status of a battery of the device, such that determining the encoding parameter comprises determining the encoding parameter based at least in part on the status of the battery.

In another example, the method above further includes determining a temperature threshold for one or more components of the device, and wherein determining the encoding parameter for encoding the video data further comprises determining the encoding parameter based on a temperature of the one or more components of the device relative to the temperature threshold.

In another example, the method above, wherein the operating characteristic of the device comprises a temperature of one or more components of the device, such that determining the encoding parameter comprises determining the encoding parameter based at least in part on the temperature.

In another example, the method above further includes determining a temperature threshold for one or more components of the device, and wherein determining the encoding parameter for encoding the video data further comprises determining the encoding parameter based on a temperature of the one or more components of the device relative to the temperature threshold.

In another example, the method above, wherein the operating characteristic of the device comprises a number of pixels of the video data that are encoded per second, such that determining the encoding parameter comprises determining the encoding parameter based at least in part on the number of pixels encoded per second.

In another example, the method above further includes determining a pixel processing threshold, and wherein determining the encoding parameter for encoding the video data further comprises determining the encoding parameter based on the number of pixels of the video data that are encoded per second relative to the pixel processing threshold.

In another example, the method above further includes determining a power budget for one or more components of the device, and wherein determining the encoding parameter for encoding the video data further comprises determining the encoding parameter based on an amount of power consumed by one or more components of the device relative to the power budget.

In another example, the method above further includes determining the amount of power consumed by the one or more components of the device based on a power model.

In another example, the method above, wherein determining the encoding parameter comprises enabling B-frames for encoding the video data.

In another example, the method above, wherein determining the encoding parameter comprises determining a search region for performing inter-predictive coding of the video data.

In another example, the method above, wherein determining the encoding parameter comprises determining whether to encode the video data with one or inter-predictive coding and intra-predictive coding.

In another example, the method above, wherein determining the encoding parameter comprises determining a set of available prediction modes for encoding the video data.

In another example, the method above further includes transcoding the video data from a first bitrate to a second, lower bitrate.

In another example, the method above, wherein transcoding the video data comprises determining a transcoding initialization trigger and transcoding the video data upon the transcoding initialization trigger occurring.

In another example, the method above, wherein the transcoding initialization trigger comprises an predetermined idle duration of the device, such that transcoding the video data comprises transcoding the video data after the device has been idle for the idle duration.

In another example, the method above, wherein the transcoding initialization trigger comprises a battery state of a battery of the device, such that transcoding the video data comprises transcoding the video data upon the battery state reaching a predetermined charge level.

In another example, the method above, wherein the transcoding initialization trigger comprises a power source status of the device, such that transcoding the video data comprises transcoding the video data upon the device being powered by an external power source.

In another example, the method above, wherein transcoding the video data comprises determining a transcoding termination trigger and stopping transcoding the video data upon the transcoding termination trigger occurring.

In another example, the method above, wherein the transcoding termination trigger comprises a change in state of the device from an idle state to an active state.

In another example, the method above, wherein the transcoding termination trigger comprises a change in power source status of the device from an external power source to an internal power source of the device.

In another example, the method above, wherein determining the encoding parameter for encoding the video data further comprises determining the encoding parameter based at least in part on an estimated power consumption of one or more components of the device.

In another example, the method above further includes determining the estimated power consumption based on or more power models for the one or more components of the device.

In another example, the method above further includes determining a storage location for storing the encoded video data, and determining the estimated power consumption based on the determined storage location.

In another example, the method above, wherein the storage location comprises one of a local storage location and a remote storage location.

In another example, the method above further includes determining a transmission process for transmitting the encoded video data, and determining the estimated power consumption based on the determined transmission process.

In another example, the method above, wherein the transmission process comprises one of a cellular transmission process and a wireless local area network (WLAN) transmission process.

In another example, the method above, wherein the one or more power models comprise at least one of a coding power model, a memory power model, a local storage power model, a cellular power model, and a wireless local area network (WLAN) power model.

It should be understood that, while certain aspects of this disclosure have been described together, the aspects, in some instances, may be independently performed. For example, the transcoding techniques described above are generally described with the encoding parameter determination/adjustment techniques. However, in other examples, the transcoding techniques may be performed independently.

Hence, it should also be understood that, in general, depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

Moreover, in one or more examples, the functions described herein may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol.

In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium. By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer.

Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium.

It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various aspects of the disclosure have been described. These and other aspects are within the scope of the following claims.

1. A method comprising:
encoding video data at a first video quality using an encoding parameter;
determining an operating characteristic of one or more components of an electronic device configured to record the video data;
adjusting the encoding parameter based at least in part on the determined operating characteristic and the first video quality; and
encoding the video data at the first video quality using the adjusted encoding parameter.

2. The method of claim 1, wherein the operating characteristic comprises a temperature of the one or more components of the device, the method further comprising:
obtaining a temperature threshold for the one or more components of the device; and
comparing the temperature to the temperature threshold;
wherein adjusting the encoding parameter further comprises adjusting the encoding parameter based on the comparison.

3. The method of claim 1, wherein the operating characteristic comprises a pixel processing rate for encoding the video data, the method further comprising:
obtaining a pixel processing rate threshold; and
wherein adjusting the encoding parameter further comprises adjusting the encoding parameter based on the pixel processing rate relative to the pixel processing rate threshold.

4. The method of claim 1, wherein the one or more components include a battery, wherein the operating characteristic comprises a status of the battery, the method further comprising:
obtaining a battery status threshold; and
wherein adjusting the encoding parameter for encoding the video data comprises adjusting the encoding parameter based on the status of the battery relative to the battery status threshold.

5. The method of claim 1, further comprising:
obtaining a power budget for the one or more components; and
wherein adjusting the encoding parameter further comprises adjusting the encoding parameter based on a power model that indicates an amount of power consumed by the one or more components relative to the power budget.

6. The method of claim 1, wherein adjusting the encoding parameter for encoding the video data comprises adjusting the encoding parameter based at least in part on an estimated power consumption of the one or more components.

7. The method of claim 6, further comprising determining the estimated power consumption based on at least one of a storage destination for the encoded video data or a transmission process for transmitting the encoded video data.

8. The method of claim 7, wherein determining the estimated power consumption comprises determining the estimated power consumption based on one or more power models including at least one of a coding power model, a memory power model, a local storage power model, a cellular power model, or a wireless local area network (WLAN) power model.

9. The method of claim 1, wherein adjusting the encoding parameter comprises enabling or disabling B-frames for encoding the video data.

10. The method of claim 1, wherein adjusting the encoding parameter comprises adjusting a search region size for performing inter-predictive coding of the video data.

11. The method of claim 1, wherein adjusting the encoding parameter comprises determining whether to encode the video data with one of inter-predictive coding or intra-predictive coding.

12. The method of claim 1, further comprising:
determining a transcoding initialization condition, wherein the transcoding initialization condition comprises at least one of a predetermined idle duration of the device, a battery state of a battery of the device, or a power source status of the device;
transcoding the video data from a first bitrate generated using the adjusted encoding parameter to a second, lower bitrate upon the determination of the transcoding initialization condition;
determining a transcoding termination condition, wherein the transcoding termination condition comprises at least one of a change in state of the device from an idle state to an active state and a change in power source status of the device from an external power source to an internal power source of the device; and
stopping the transcoding of the video data upon the determination of the transcoding termination condition.

13. The method of claim 1, wherein maintaining the first video quality comprises altering a compression ratio of the encoded video data.

14. The method of claim 1, further comprising setting, at a fixed level, at least one of a resolution of the video data, a frame rate of the video data, and a signal to noise ratio of the video data when encoding the video data to maintain the first video quality when the video data is encoded at the first video quality using the adjusted encoding parameter.

15. An electronic device comprising:
one or more components configured to record video data;
a memory configured to store the video data; and
one or more processors configured to:
encode video data at a first video quality using an encoding parameter;
determine an operating characteristic of the one or more components of the electronic device configured to record the video data;
adjust the encoding parameter based at least in part on the determined operating characteristic and the first video quality; and
encode the video data at the first video quality using the adjusted encoding parameter.

16. The electronic device of claim 15, wherein the operating characteristic comprises a temperature of the one or more components of the device, and wherein the one or more processors are further configured to:
obtain a temperature threshold for the one or more components of the device;
compare the temperature to the temperature threshold; and
wherein to adjust the encoding parameter, the one or more processors are configured to adjust the encoding parameter based on the comparison.

17. The electronic device of claim 15, wherein the operating characteristic comprises a pixel processing rate for encoding the video data, and wherein the one or more processors are further configured to:
obtain a pixel processing rate threshold; and
wherein to adjust the encoding parameter, the one or more processors are configured to adjust the encoding parameter based on the pixel processing rate relative to the pixel processing rate threshold.

18. The electronic device of claim 15, wherein the one or more components include a battery, wherein the operating characteristic comprises a status of the battery, and wherein the one or more processors are configured to:
obtain a battery status threshold; and
wherein to adjust the encoding parameter for encoding the video data, the one or more processors are configured to adjust the encoding parameter based on the status of the battery relative to the battery status threshold.

19. The electronic device of claim 15, wherein the one or more processors are further configured to:
obtain a power budget for the one or more components; and
wherein to adjust the encoding parameter, the one or more processors are configured to adjust the encoding parameter based on a power model that indicates an amount of power consumed by the one or more components relative to the power budget.

20. The electronic device of claim 15, wherein to adjust the encoding parameter for encoding the video data, the one or more processors are configured to adjust the encoding parameter based at least in part on an estimated power consumption of the one or more components.

21. The electronic device of claim 20, wherein the one or more processors are further configured to determine the estimated power consumption based on at least one of a storage destination for the encoded video data, or a transmission process for transmitting the encoded video data.

22. The electronic device of claim 21, wherein to determine the estimated power consumption, the one or more processors are configured to determine the estimated power consumption based on one or more power models including at least one of a coding power model, a memory power model, a local storage power model, a cellular power model, or a wireless local area network (WLAN) power model.

23. The electronic device of claim 15, wherein to adjust the encoding parameter, the one or more processors are configured to enable or disabling B-frames for encoding the video data.

24. The electronic device of claim 15, wherein to adjust the encoding parameter, the one or more processors are configured to adjust a search region size for performing inter-predictive coding of the video data.

25. The electronic device of claim 15, wherein to adjust the encoding parameter, the one or more processors are configured to determine whether to encode the video data with one of inter-predictive coding or intra-predictive coding.

26. The electronic device of claim 15, wherein the one or more processors are further configured to:
determine a transcoding initialization condition, wherein the transcoding initialization condition comprises at least one of a predetermined idle duration of the device, a battery state of a battery of the device, or a power source status of the device;
transcode the video data from a first bitrate generated using the adjusted encoding parameter to a second, lower bitrate upon the determination of the transcoding initialization condition;
determine a transcoding termination condition, wherein the transcoding termination condition comprises at least one of a change in state of the device from an idle state to an active state and a change in power source status of the device from an external power source to an internal power source of the device; and
stop the transcoding of the video data upon the determination of the transcoding termination condition.

27. The electronic device of claim 15, wherein to maintain the first video quality, the one or more processors are configured to alter a compression ratio of the encoded video data.

28. The electronic device of claim 15, wherein the one or more processors are further configured to set, at a fixed level, at least one of a resolution of the video data, a frame rate of the video data, and a signal to noise ratio of the video data when encoding the video data to maintain the first video quality when the video data is encoded at the first video quality using the adjusted encoding parameter.

29. An apparatus comprising:
means for encoding video data at a first video quality using an encoding parameter;
means for determining an operating characteristic of one or more components of an electronic device configured to record the video data;
means for adjusting the encoding parameter based at least in part on the determined operating characteristic and the first video quality; and
means for encoding the video data at the first video quality using the adjusted encoding parameter.

30. A non-transitory computer-readable medium having instructions stored thereon that, when executed, cause one or more processors of an electronic device to:
encode video data at a first video quality using an encoding parameter;
determine an operating characteristic of one or more components of an electronic device configured to record the video data;
adjust the encoding parameter based at least in part on the determined operating characteristic and the first video quality; and
encode the video data at the first video quality using the adjusted encoding parameter.
